(19) United States
(12) Patent Application Publication
(10) Pub. No.: US 2026/0215432 A1
(43) Pub. Date: Jul. 30, 2026

(54) ANTIMICROBIAL CONJUGATED OLIGOELECTROLYTES AND METHODS THEREOF

(71) Applicant: National University of Singapore, Singapore (SG)

(72) Inventors: Guillermo BAZAN, Singapore (SG); Kaixi ZHANG, Singapore (SG); Jun Wei Samuel CHAN, Singapore (SG)

(73) Assignee: National University of Singapore, Singapore (SG)

(21) Appl. No.: 19/145,797

(22) PCT Filed: Jan. 5, 2024
(86) PCT No.: PCT/SG2024/050013

§ 371 Date: Jul. 3, 2025

(30) Foreign Application Priority Data
Jan. 6, 2023 (SG) 10202300046W

(51) Int. Cl. A01N 57/22; A01P 1/00; C07F 9/54

(52) U.S. Cl. CPC A01N 57/22; C07F 9/5442; A01P 1/00

(57) ABSTRACT

The present disclosure relates, in general terms, to conjugated oligoelectrolytes which are antimicrobial and their methods of use thereof. The compounds may be used to treat a bacterial infection or disease.

### TECHNICAL FIELD

The present disclosure relates, in general terms, to conjugated oligoelectrolytes which are antimicrobial and their methods of use thereof.

### BACKGROUND

Antimicrobial resistance is recognized as one of the leading public health issues today. This challenge is exacerbated by antibiotic overuse and drug development challenges. There is therefore a clear need for the discovery of new antibiotic classes capable of combating multi-drug resistant (MDR) priority pathogens that current options fail to address. Membrane-active molecules are an attractive platform to develop such novel antibiotics due to their rapid bactericidal activity and limited resistance development. For example, membranolytic antimicrobial peptides (AMPs) are naturally occurring bioactive compounds that have aroused much interest due to their bactericidal activity and minimal likelihood of resistance development attributed to their membrane permeabilizing mode of action. However, AMPs exhibit inherent challenges including proteolytic instability and synthetic costs. Synthetic efforts to circumvent these challenges include the design of cationic polymers, synthetic peptide oligomers, and amphiphiles-compounds that encompass the essential membrane specific mechanisms of AMPs. Central to all these developments is controlling the hydrophobic-hydrophilic balance to design molecules capable of penetrating and modifying the bacterial membrane.

It would be desirable to overcome or ameliorate at least one of the above-described problems, or at least to provide a useful alternative.

### SUMMARY

The present disclosure relates to a compound of Formula (I) or a pharmaceutically acceptable salt, solvate or isomer thereof:

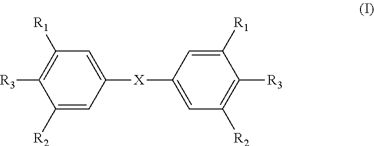

wherein
each R₁, R₂ and R₃ are independently selected from H, optionally substituted alkyl, optionally substituted alkoxy;
wherein each phenylene ring comprises at least one

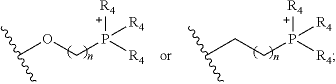

wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 2 to 10; and
X is a linker configured to maintain the n-n conjugation between the two phenylene rings.

In some embodiments, X is selected from

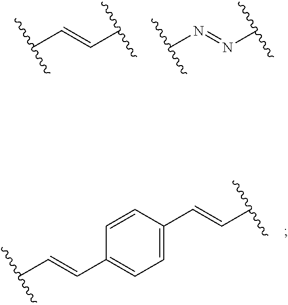

wherein [symbol] represents a bond to either phenylene ring.

The present disclosure relates to a compound of Formula (IIa) or a pharmaceutically acceptable salt, solvate or isomer thereof:

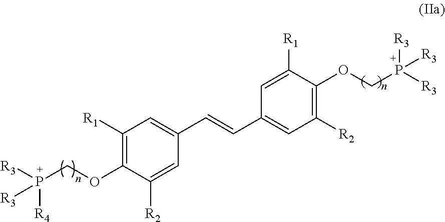

wherein
each R₁ is independently selected from H, optionally substituted alkyl, and optionally substituted alkoxy;
each R₂ is independently selected from H, optionally substituted alkyl, and optionally substituted alkoxy;
each R₃ is independently selected from optionally substituted aryl, optionally substituted heteroaryl, optionally substituted heterocyclyl, optionally substituted cycloalkyl, and optionally substituted cycloalkenyl; and
n is an integer selected from 4 to 10.

In some embodiments, R₁ is independently optionally substituted methoxy and R₂ is H.

In some embodiments, at least one R₄ is optionally substituted aryl.

In some embodiments, the compound of Formula (I) or (IIa) is characterised by a trans or E configuration.

In some embodiments, the compound of Formula (I) or (IIa) is selected from:

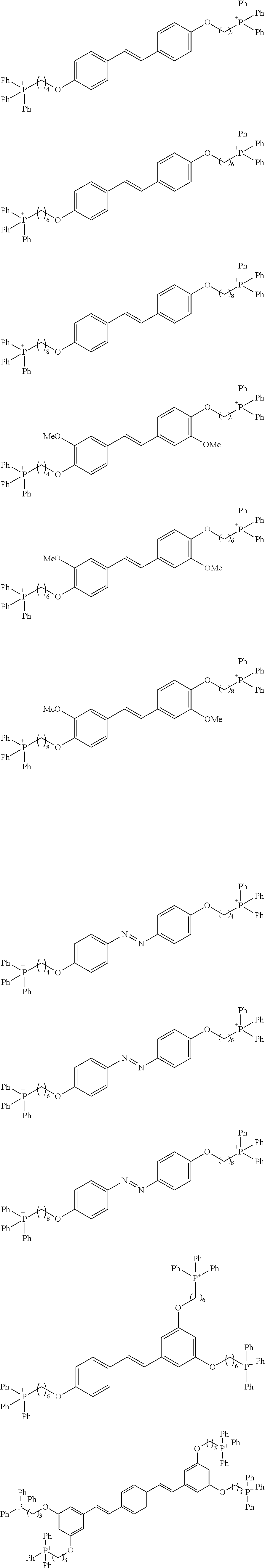

In some embodiments, the compound of Formula (I) or (IIa) is characterised by a solubility in an aqueous medium of about 2 μg mL⁻¹ to about 200 μg mL⁻¹.

In some embodiments, the compound of Formula (I) or (IIa) is characterised by a solubility in an aqueous medium of about 4 μg mL⁻¹ to about 138 μg mL⁻¹.

In some embodiments, the compound of Formula (I) or (IIa) is characterised by a minimum inhibitory concentration (MIC) against microbe of about 0.5 μg mL⁻¹ to about 64 μg mL⁻¹.

In some embodiments, the compound of Formula (I) or (IIa) is characterised by a minimum inhibitory concentration (MIC) against Gram-negative bacteria of about 0.5 ug mL⁻¹ to about 64 μg mL⁻¹.

In some embodiments, the compound of Formula (I) or (IIa) is characterised by a minimum inhibitory concentration (MIC) against Gram-positive bacteria of about 0.5 μg mL⁻¹ to about 16 μg mL⁻¹.

In some embodiments, the MIC is not affected by a presence of protein and/or salt in the aqueous medium.

In some embodiments, the compound of Formula (I) or (IIa) is characterised by a IC₅₀ against mammalian cells of about 5 μg mL⁻¹ to about 256 μg mL⁻¹.

In some embodiments, the compound of Formula (I) or (IIa) is characterised by a selectivity index (IC₅₀/MIC) of about 2 to about 100.

In some embodiments, the compound of Formula (I) or (IIa) is characterised by a minimum bactericidal concentration (MBC) of about 0.5 μg mL⁻¹ to 64 μg mL⁻¹.

In some embodiments, the microbe does not develop a resistance after contact with the compound of Formula (I) or (IIa).

In some embodiments, a bacterial membrane in a bacterial cell is depolarized after contact with the compound of Formula (I) or (IIa).

The present disclosure also relates to a pharmaceutical composition, comprising a compound of Formula (I) or (IIa) or a pharmaceutically acceptable salt, solvate or isomer thereof, and optionally in combination with an excipient.

The present disclosure also relates to a composition, comprising a compound of Formula (I) or (IIa) or a salt, solvate or isomer thereof, and optionally in combination with an excipient.

The present disclosure also relates to a method of treating a bacterial infection or disease, comprising administrating to a subject in need thereof a therapeutical effective amount of the compound of Formula (I) or (IIa) or a pharmaceutically acceptable salt, solvate or isomer thereof.

The present disclosure also relates to a compound of Formula (I) or (IIa) or a pharmaceutically acceptable salt, solvate or isomer thereof for use in treating a bacterial infection or disease.

The present disclosure also relates to use of a compound of Formula (I) or (IIa) or a pharmaceutically acceptable salt, solvate or isomer thereof in the manufacture of a medicament for treating a bacterial infection or disease.

In some embodiments, the compound of (I) or (IIa) or a pharmaceutically acceptable salt, solvate or isomer thereof is provided to the subject in need thereof at about 0.05 mg/kg to about 10 mg/kg.

In some embodiments, the bacteria in the bacterial infection or disease is an antibiotic resistant bacteria.

In some embodiments, the bacteria in the bacterial infection or disease is a Gram-negative bacterial or Gram-positive bacteria.

In some embodiments, the bacteria is selected from E. coli, P. aeruginosa, K. pneumonia, A. baumanii, S. aureus, Methicillin-resistant S. aureus, E. faecalis, E. facium, and non-tuberculous mycobacteria.

In some embodiments, the bacterial infection or disease is a bacteria skin infection or food-borne infection.

The present disclosure also relates to a method of disinfecting a surface, comprising contacting the compound of Formula (I) with the surface.

In some embodiments, the surface is a non-biological surface.

### BRIEF DESCRIPTION OF THE DRAWINGS

Embodiments of the present invention will now be described, by way of non-limiting example, with reference to the drawings in which:

FIG. 1 shows (a) a schematic of the various modular subunits of antimicrobial COEs. (b) General structure of previously explored quaternary ammonium COEs. (c) TPP analogues in this study.

FIG. 2 shows synthetic route towards phosphonium COEs.

FIG. 3 shows time-kill kinetics of DM6P towards both MRSA (a) and PAO1 (b) at varying concentrations. Dashed lines indicate the threshold at which 99.9% of bacteria were killed. Limit of detection=100 cfu mL⁻¹.

FIG. 4 shows serial passaging of bacteria treated with DM6P at sub-MIC concentrations demonstrates the lack of resistance development (two independent biological replicates per compound). Data plotted relative to the MIC values at the start of the experiment.

FIG. 5 shows membrane permeabilization of bacterial cells (PAO1 (Gram-negative, left) and MRSA (Gram-positive, right)) over time at varying concentrations as a function of the MIC value (4 μg mL⁻¹ against PAO1 and 1 μg mL⁻¹ against MRSA). (a) Membrane depolarization assay. The increase in fluorescence intensity is correlated with the change in membrane potential. Values were normalized to complete depolarization induced by 0.2% (v/v) Triton-X-100. (b) Cytoplasmic membrane permeabilization as measured by propidium iodide influx (30 μM).

FIG. 6 shows live-dead staining of P. aeruginosa treated with DM6P at 2×MIC (8 μg mL⁻¹) for 30 minutes with SYTO-9/PI (5 μM/30 μM respectively). Scale bar=2 μm

FIG. 7 shows representative TEM images of MRSA cells treated with DM6P. Cells were incubated with the compound at 4 mg mL⁻¹ (4×MIC) for 30 minutes. White arrows indicate regions of membrane destabilization. White regions feature the absence of electron-dense intracellular regions.

FIG. 8 shows in vivo efficacy of representative TPP-COEs in murine wound models. Treatment of MRSA-inoculated mice with either 0.05 mg kg⁻¹ or 0.25 mg kg⁻¹ DM6P (n=4). Mice were sacrificed after 24 hours, and bacteria colonies were enumerated on agar plates (p<0.0005, one-way ANOVA vs. saline control). Dotted line represents the inoculum cfu per wound (6.02).

FIG. 9 shows the in vivo efficacy of representative TPP-COE against S. pseudintermedius treated with either 0.1 mg kg⁻¹ or 0.25 mg kg⁻¹ of DM6P compared against the untreated vehicle control. Bacteria load was sampled at 12 hours post-treatment and inoculated on agar plates (p<0.05, one-way ANOVA vs. saline control).

FIG. 10 shows the in vivo efficacy of representative TPP-COE against S. pseudintermedius treated with either 0.1 mg kg⁻¹ or 0.25 mg kg⁻¹ of DM6P compared against the untreated vehicle control. Mice were sacrificed after 24 hours, and bacteria colonies were enumerated on agar plates (p<0.05, one-way ANOVA vs. saline control).

FIG. 11 shows structures of other compounds of the present disclosure.

### DETAILED DESCRIPTION

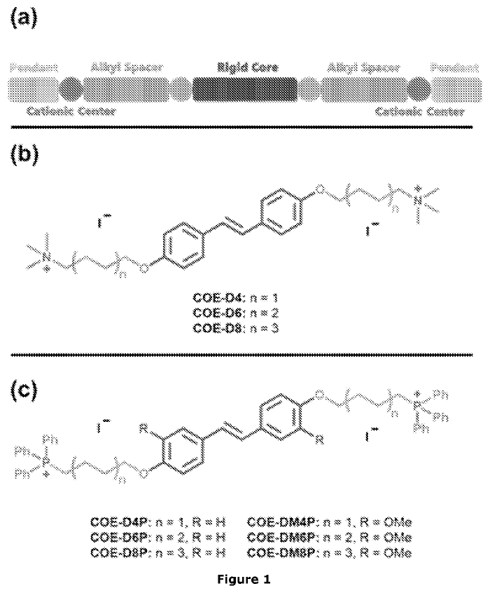

The present disclosure is predicated on the understanding that certain conjugated oligoelectrolytes (COEs) have been previously shown to have antimicrobial activity. They feature a linear hydrophobic n-conjugated core flanked by nitrogen-based cationic pendant groups that promote association with negatively charged microbial cell membranes (FIG. 1a). Molecular topology, hydrophobicity, and the chemical identity of the cationic group provide structural factors that influence interactions with lipid bilayers and consequently bactericidal properties. Substantial efforts have been placed on balancing the hydrophobic domains of the pendant and spacer alkyl subunits to afford high selectivity towards bacteria. Previous work has also highlighted that decreasing the overall solubility of the molecule through increasing molecular length improves activity through increased cellular association.

The cationic groups for antimicrobial COEs remains largely limited to quaternary ammonium (QA) functionalities, which are a challenging drug motif due to potential off target interactions. This general problem with ammonium functionalities has led to the examination of other cationic species in drug design. Without wanting to be bound by theory, the inventors believe that benzyltriphenyl-phosphonium salts may have anti-microbial activity, and a membrane-targeting motif functionalised with triphenyl-phosphonium moiety may be used as an antimicrobial agent with improved activity over pre-existing leads.

Accordingly, the present disclosure concerns a class of COEs that takes advantage of cationic triarylphosphonium (TPP) functionalities to achieve solubility in aqueous media and compare their antimicrobial effects to structurally related quaternary ammonium analogues (FIGS. 1b, 1c and 9). The inventors took into account that antimicrobial activity can be improved through enhancing its lipophilicity, a factor that plays a central role in enabling compounds to better pass through the cell membrane. Moreover, the delocalization of charge over the larger TPP moiety was anticipated to potentially modify the membrane interacting properties and therefore potentially selectivity. To attenuate possible complications arising from lower aqueous solubility, the inventors also examined chemical substitution on the stilbene core. Perturbing n-n interactions between hydrophobic stilbene units was anticipated to reduce the propensity of the molecule to pack together and be a viable method of improving the bioavailability. For example, a methoxy substituent may be chosen (Scheme 1c, R=OMe series). Alternatively, the alkenylene linker may be modified. Based on these modifications, the inventors examined the effect of TPP cation substitution on the antimicrobial activity of an existing stilbene COE scaffold through a systematic study of its activity spectrum towards various bacteria strains. The influence of this lipophilic group on COE interactions with bacteria membranes was also investigated. Finally, in vivo performance against both community-acquired methicillin-resistant Staphylococcus aureus (CA-MRSA) and Staphylococcus pseudintermedius in a murine skin infection model was demonstrated.

The present disclosure relates to a compound of Formula (I) or a pharmaceutically acceptable salt, solvate or isomer thereof:

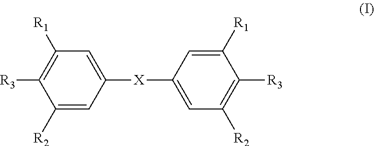

wherein
each R₁, R₂ and R₃ are independently selected from H, optionally substituted alkyl, optionally substituted alkoxy;
wherein each phenylene ring comprises at least one

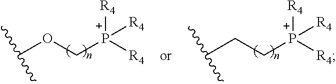

wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 2 to 10; and
X is a linker configured to maintain the n-n conjugation between the two phenylene rings.

At least one of R₁, R₂ and R₃ on each phenylene ring is

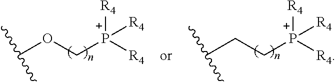

Accordingly, there may independently be one, two or three

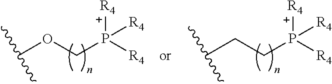

on each phenylene ring. Any of R₁, R₂ and R₃ one each phenylene ring may independently be

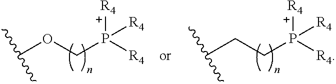

In some embodiments, at least one of R₁, R₂ and R₃ on each phenylene ring is

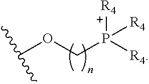

The π (pi) system of a molecule is formed by the interaction of unhybridized p atomic orbitals on atoms that have sp²- and sp-hybridization. The interaction that results in n bonding takes place between p orbitals that are adjacent by virtue of a σ bond joining the atoms and takes the form of side-to-side overlap of p orbitals.

In some embodiments, X is selected from:

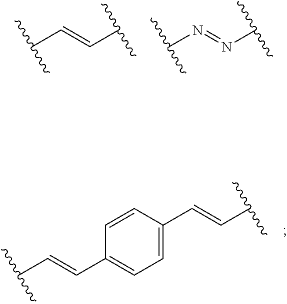

wherein [symbol] represents a bond to either phenylene ring.

In some embodiments, the compound of Formula (I) is a compound of Formula (II) or a pharmaceutically acceptable salt, solvate or isomer thereof:

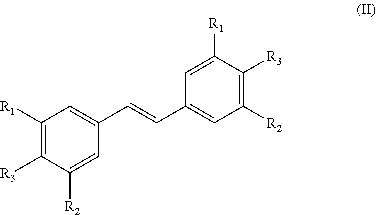

wherein
each R₁, R₂ and R₃ are independently selected from H, optionally substituted alkyl, optionally substituted alkoxy;
wherein each phenylene ring comprises at least one

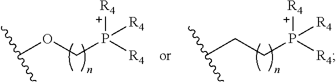

wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 2 to 10.

The present disclosure relates to a compound of Formula (IIa) or a pharmaceutically acceptable salt, solvate or isomer thereof:

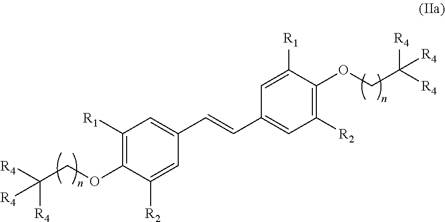

wherein
each R₁ is independently selected from H, optionally substituted alkyl, and optionally substituted alkoxy;
each R₂ is independently selected from H, optionally substituted alkyl, and optionally substituted alkoxy;
each R₄ is independently selected from optionally substituted aryl, optionally substituted heteroaryl, optionally substituted heterocyclyl, optionally substituted cycloalkyl, and optionally substituted cycloalkenyl; and
n is an integer selected from 4 to 10.

In some embodiments, the compound of Formula (I) is a compound of Formula (III) or a pharmaceutically acceptable salt, solvate or isomer thereof:

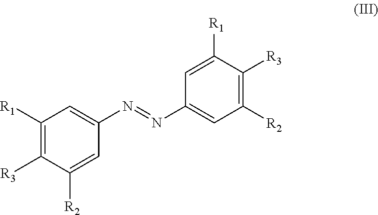

wherein
each R₁, R₂ and R₃ are independently selected from H, optionally substituted alkyl, optionally substituted alkoxy;
wherein each phenylene ring comprises at least one

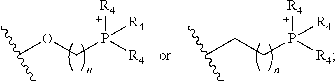

wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 3 to 10.

In some embodiments, the compound of Formula (III) is a compound of Formula (IIIa) or a pharmaceutically acceptable salt, solvate or isomer thereof:

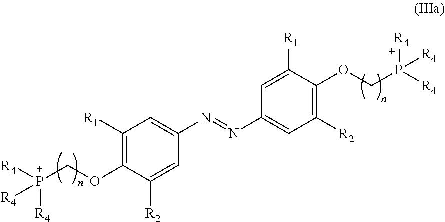

wherein
each R₁ is independently selected from H, optionally substituted alkyl, and optionally substituted alkoxy;
each R₂ is independently selected from H, optionally substituted alkyl, and optionally substituted alkoxy;
each R₄ is independently selected from optionally substituted aryl, optionally substituted heteroaryl, optionally substituted heterocyclyl, optionally substituted cycloalkyl, and optionally substituted cycloalkenyl; and
n is an integer selected from 2 to 10.

In some embodiments, the compound of Formula (I) is a compound of Formula (IV) or a pharmaceutically acceptable salt, solvate or isomer thereof:

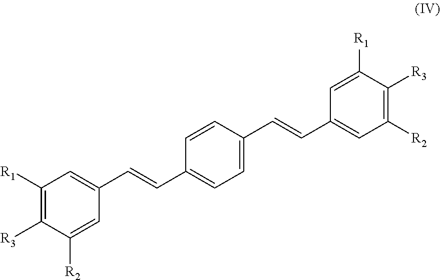

wherein
each R₁, R₂ and R₃ are independently selected from H, optionally substituted alkyl, optionally substituted alkoxy;
wherein each phenylene ring comprises at least one

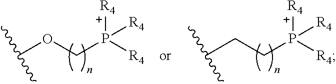

wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 2 to 10.

In some embodiments, the compound of Formula (IV) is a compound of Formula (IVa) or a pharmaceutically acceptable salt, solvate or isomer thereof:

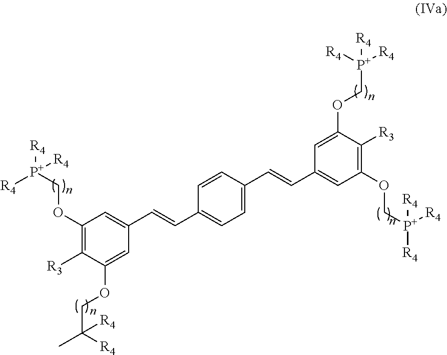

wherein
each R₃ is independently selected from H, optionally substituted alkyl, and optionally substituted alkoxy;
each R₄ is independently selected from optionally substituted aryl, optionally substituted heteroaryl, optionally substituted heterocyclyl, optionally substituted cycloalkyl, and optionally substituted cycloalkenyl; and
n is an integer selected from 3 to 10.

“Alkyl” refers to monovalent alkyl groups which may be straight chained or branched and preferably have from 1 to 10 carbon atoms or more preferably 1 to 6 carbon atoms. Examples of such alkyl groups include methyl, ethyl, n-propyl, iso-propyl, n-butyl, iso-butyl, n-hexyl, and the like.

“Alkoxy” refers to the group alkyl-O— where the alkyl group is as described above. Examples include, methoxy, ethoxy, n-propoxy, iso-propoxy, n-butoxy, tert-butoxy, sec-butoxy, n-pentoxy, n-hexoxy, 1,2-dimethylbutoxy, and the like.

“Aryl” refers to an unsaturated aromatic carbocyclic group having a single ring (eg. phenyl) or multiple condensed rings (eg. naphthyl or anthryl), preferably having from 6 to 14 carbon atoms. Examples of aryl groups include phenyl, naphthyl and the like.

“Heteroaryl” refers to a monovalent aromatic heterocyclic group which fulfils the Hückel criteria for aromaticity (ie. contains 4n+2 n electrons) and preferably has from 2 to 10 carbon atoms and 1 to 4 heteroatoms selected from oxygen, nitrogen, selenium, and sulfur within the ring (and includes oxides of sulfur, selenium and nitrogen). Such heteroaryl groups can have a single ring (eg. pyridyl, pyrrolyl or N-oxides thereof or furyl) or multiple condensed rings (eg. indolizinyl, benzoimidazolyl, coumarinyl, quinolinyl, isoquinolinyl or benzothienyl).

Examples of heteroaryl groups include, but are not limited to, oxazole, pyrrole, imidazole, pyrazole, pyridine, pyrazine, pyrimidine, pyridazine, indolizine, isoindole, indole, indazole, purine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, isothiazole, phenoxazine, phenothiazine, thiazole, thiadiazoles, oxadiazole, oxatriazole, tetrazole, thiophene, benzo[b]thiophene, triazole, imidazopyridine and the like.

“Cycloalkyl” refers to cyclic alkyl groups having a single cyclic ring or multiple condensed rings, preferably incorporating 3 to 11 carbon atoms. Such cycloalkyl groups include, by way of example, single ring structures such as cyclopropyl, cyclobutyl, cyclopentyl, cyclohexyl, cyclooctyl, and the like, or multiple ring structures such as adamantanyl, indanyl, 1,2,3,4-tetrahydronapthalenyl and the like.

“Heterocyclyl” refers to a monovalent saturated or unsaturated group having a single ring or multiple condensed rings, preferably from 1 to 8 carbon atoms and from 1 to 4 hetero atoms selected from nitrogen, sulfur, oxygen, selenium or phosphorous within the ring. The most preferred heteroatom is nitrogen. It will be understood that where, for instance, R₂ or R′ is an optionally substituted heterocyclyl which has one or more ring heteroatoms, the heterocyclyl group can be connected to the core molecule of the compounds of the present invention, through a C—C or C-heteroatom bond, in particular a C—N bond.

Examples of heterocyclyl and heteroaryl groups include, but are not limited to, oxazole, pyrrole, imidazole, pyrazole, pyridine, pyrazine, pyrimidine, pyridazine, indolizine, isoindole, indole, indazole, purine, quinolizine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, isothiazole, phenoxazine, phenothiazine, imidazolidine, imidazoline, piperidine, piperazine, indoline, phthalimide, 1,2,3,4-tetrahydroisoquinoline, 4,5,6,7-tetrahydrobenzo[b]thiophene, thiazole, thiadiazoles, oxadiazole, oxatriazole, tetrazole, thiazolidine, thiophene, benzo[b]thiophene, morpholino, piperidinyl, pyrrolidine, tetrahydrofuranyl, triazole, and the like.

In this specification “optionally substituted” is taken to mean that a group may or may not be further substituted or fused (so as to form a condensed polycyclic group) with one or more groups selected from hydroxyl, acyl, alkyl, alkoxy, alkenyl, alkenyloxy, alkynyl, alkynyloxy, amino, aminoacyl, thio, arylalkyl, arylalkoxy, aryl, aryloxy, carboxyl, acylamino, cyano, halogen, nitro, phosphono, sulfo, phosphorylamino, phosphinyl, heteroaryl, heteroarylalkyl, heteroaryloxy, heterocyclyl, heterocyclylalkyl, heterocyclyloxy, oxyacyl, oxime, oxime ether, hydrazone, oxyacylamino, oxysulfonylamino, aminoacyloxy, trihalomethyl, trialkylsilyl, pentafluoroethyl, trifluoromethoxy, difluoromethoxy, trifluoromethanethio, trifluoroethenyl, mono- and di-alkylamino, mono- and di-(substituted alkyl)amino, mono- and di-arylamino, mono- and di-heteroarylamino, mono- and di-heterocyclyl amino, and unsymmetric di-substituted amines having different substituents selected from alkyl, aryl, heteroaryl and heterocyclyl, and the like, and may also include a bond to a solid support material, (for example, substituted onto a polymer resin). For instance, an “optionally substituted amino” group may include amino acid and peptide residues.

Compounds described herein can comprise one or more asymmetric centers, and thus can exist in various isomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. The invention additionally encompasses compounds described herein as individual isomers substantially free of other isomers, and alternatively, as mixtures of various isomers. “Optically-enriched,” as used herein, means that the compound is made up of a significantly greater proportion of one enantiomer. In certain embodiments the compound of the present invention is made up of at least about 90% by weight of a preferred enantiomer. In other embodiments the compound is made up of at least about 95%, 98%, or 99% by weight of a preferred enantiomer. Preferred enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques et al., Enantiomers, Racemates and Resolutions (Wiley Interscience, New York, 1981); Wilen et al., Tetrahedron 33:2725 (1977); Eliel, Stereochemistry of Carbon Compounds (McGraw-Hill, NY, 1962); and Wilen, Tables of Resolving Agents and Optical Resolutions p. 268 (E. L. Eliel, Ed., Univ. of Notre Dame Press, Notre Dame, IN 1972).

Conjugated oligoelectrolytes (COEs) are a class of molecules defined by a hydrophobic conjugated core bearing terminal polar ionic pendants. In particular embodiments, the hydrophobic and hydrophilic moieties in COEs can be rationally designed into the molecule such that they mirror the organization of hydrophilic and hydrophobic domains in lipid bilayers. This structural design typically involves only unbranched internal structures with charged groups at the two termini so that it favours the spontaneous intercalation of COEs into cellular membranes, which is driven by electrostatic and hydrophobic interactions between the COEs and the lipids.

The compounds of the present invention have a substantially linear topology. The topology refers to a molecular structure of a compound within the constraints of three-dimensional (3D) space. Such linear topology has two nodes as the termini without any junction nodes. The linear topology is advantageous for facilitating lipid membrane intercalation.

In some embodiments, each R₁ is independently selected from H, and optionally substituted alkoxy. In some embodiments, each R₁ is independently selected from H, optionally substituted methoxy, optionally substituted ethoxy, and optionally substituted propoxy. In some embodiments, each R₁ is independently selected from H, optionally substituted methoxy, and optionally substituted C₄-C₁₀ alkoxy terminated with a phosphonium moiety. The phosphonium moiety may be a triarylphosphonium moiety.

In some embodiments, each R₂ is independently selected from H, and optionally substituted alkoxy. In some embodiments, each R₂ is independently selected from H, optionally substituted methoxy, optionally substituted ethoxy, and optionally substituted propoxy. In some embodiments, each R₂ is independently selected from H, optionally substituted methoxy, and optionally substituted C₄-C₁₀ alkoxy terminated with a phosphonium moiety. The phosphonium moiety may be a triarylphosphonium moiety.

In some embodiments, each R₃ is independently selected from H, and optionally substituted alkoxy. In some embodiments, each R₃ is independently selected from H, optionally substituted methoxy, optionally substituted ethoxy, and optionally substituted propoxy. In some embodiments, each R₃ is independently selected from H, optionally substituted methoxy, and optionally substituted C₄-C₁₀ alkoxy terminated with a phosphonium moiety. The phosphonium moiety may be a triarylphosphonium moiety.

In some embodiments, R₁ is independently optionally substituted methoxy and R₂ is H.

As mentioned above, the compounds of the present disclosure comprises at least a terminal polar ionic pendants at each end thereof. The ionic pendant may be optionally substituted C₄-C₁₀ alkoxy terminated with a phosphonium moiety. The ionic pendant may be at R₁, R₂ and/or R₃.

In some embodiments, at least one of R₁, R₂ and R₃ on each phenylene ring is

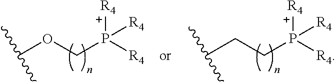

In some embodiments, at least two of R₁, R₂ and R₃ on each phenylene ring is

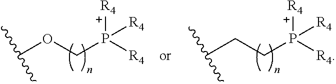

In some embodiments, R₃ on each phenylene ring is

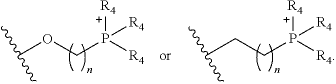

In some embodiments, R₃ on one phenylene ring is

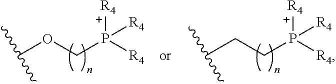

and R₁ and R₂ on the other phenylene ring are

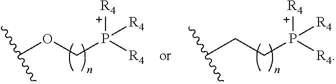

In some embodiments, R₁ and R₂ on each phenylene ring is

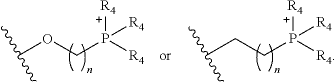

In some embodiments, at least one of R₁, R₂ and R₃ on each phenylene ring is

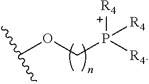

In some embodiments, at least two of R₁, R₂ and R₃ on each phenylene ring is

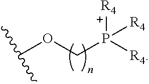

In some embodiments, R₃ on each phenylene ring is

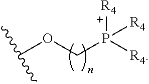

In some embodiments, R₃ on one phenylene ring is

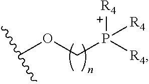

and R₁ and R₂ on the other phenylene ring are

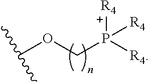

In some embodiments, R₁ and R₂ on each phenylene ring is

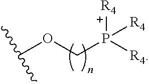

In some embodiments, each R₄ is independently selected from optionally substituted aryl, and optionally substituted heteroaryl. In some embodiments, each R₃ is optionally substituted aryl. In some embodiments, each R₃ is optionally substituted phenyl.

In some embodiments, at least one R₄ is optionally substituted aryl. In some embodiments, at least two R₄ is optionally substituted aryl. In this regard, the two aryl moieties may be attached to a single phosphonium ion, or each aryl moiety may be attached to each phosphonium ion. In some embodiments, at least three R₄ is optionally substituted aryl. In some embodiments, at least four R₄ is optionally substituted aryl. In some embodiments, at least five R₃ is optionally substituted aryl.

In some embodiments, n is an integer selected from 2 to 9, or 3 to 9. In some embodiments, n is an integer selected from 4 to 9. In some embodiments, n is an integer selected from 4 to 8. In some embodiments, n is an integer selected from 4, 6, and 8.

In some embodiments, the compound of Formula (I), (II), (III) and (IV) are characterised by a trans or E configuration.

In some embodiments, the compound of Formula (I), (II), (III) and (IV) are selected from:

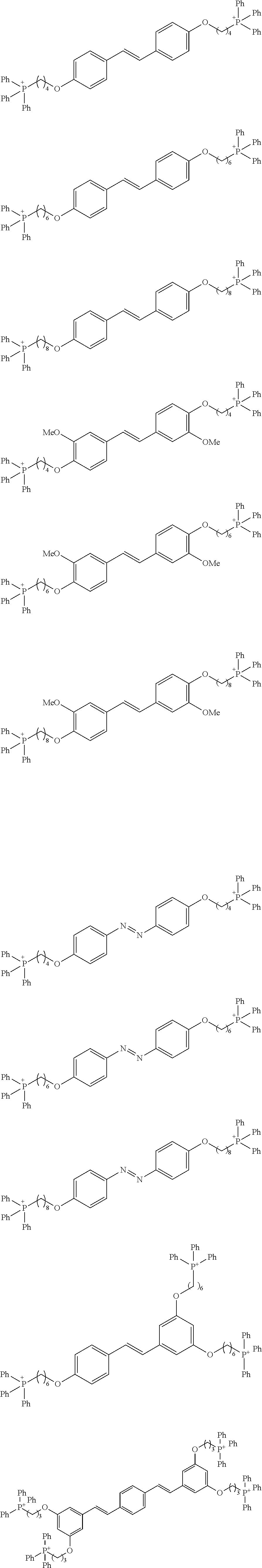

In some embodiments, the compound of Formula (II) is selected from:

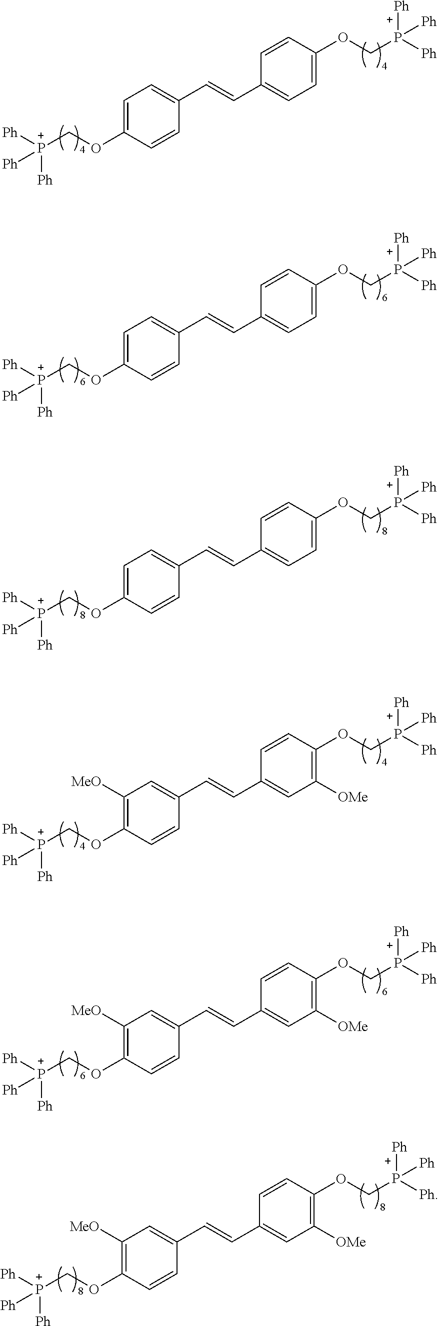

In some embodiments, the compound of Formula (I), (II), (III) and (IV) are characterised by a solubility in an aqueous medium of about 2 μg mL⁻¹ to about 200 μg mL⁻¹. In some embodiments, the solubility is about 2 μg mL⁻¹ to about 180 μg mL⁻¹, about 2 μg mL⁻¹ to about 160 μg mL⁻¹, about 2 μg mL⁻¹ to about 140 μg mL⁻¹, about 2 μg mL⁻¹ to about 120 μg mL⁻¹, about 2 μg mL⁻¹ to about 100 μg mL⁻¹. In some embodiments, the compound of Formula (I) is characterised by a solubility in an aqueous medium of about 4 μg mL⁻¹ to about 138 μg mL⁻¹.

The term “aqueous medium” used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also fall within this definition.

In some embodiments, the compound of Formula (I), (II), (III) and (IV) are characterised by a minimum inhibitory concentration (MIC) against microbe of about 0.5 μg mL⁻¹ to about 64 μg mL⁻¹. In other embodiments, the minimum inhibitory concentration (MIC) is about 0.5 μg mL⁻¹ to about 60 μg mL⁻¹, about 0.5 μg mL⁻¹ to about 55 μg mL⁻¹, about 0.5 μg mL⁻¹ to about 50 μg mL⁻¹, about 0.5 μg mL⁻¹ to about 45 μg mL⁻¹, about 0.5 μg mL⁻¹ to about 40 μg mL⁻¹, about 0.5 μg mL⁻¹ to about 35 μg mL⁻¹, or about 0.5 μg mL⁻¹ to about 30 μg mL⁻¹.

In some embodiments, the compound of Formula (I), (II), (III) and (IV) are characterised by a minimum inhibitory concentration (MIC) against Gram-negative bacteria of about 0.5 μg mL⁻¹ to about 64 μg mL⁻¹. In other embodiments, the minimum inhibitory concentration (MIC) is about 0.5 μg mL⁻¹ to about 60 μg mL⁻¹, about 0.5 μg mL⁻¹ to about 55 μg mL⁻¹, about 0.5 μg mL⁻¹ to about 50 μg mL⁻¹, about 0.5 μg mL⁻¹ to about 45 μg mL⁻¹, about 0.5 μg mL⁻¹ to about 40 μg mL⁻¹, about 0.5 μg mL⁻¹ to about 35 μg mL⁻¹, or about 0.5 μg mL⁻¹ to about 30 μg mL⁻¹.

In some embodiments, the compound of Formula (I), (II), (III) and (IV) are characterised by a minimum inhibitory concentration (MIC) against Gram-positive bacteria of about 0.5 μg mL⁻¹ to about 16 μg mL⁻¹. In other embodiments, the minimum inhibitory concentration (MIC) is about 0.5 μg mL⁻¹ to about 15 μg mL⁻¹, about 0.5 μg mL⁻¹ to about 14 μg mL⁻¹, about 0.5 μg mL⁻¹ to about 13 μg mL⁻¹, about 0.5 μg mL⁻¹ to about 12 μg mL⁻¹, about 0.5 μg mL⁻¹ to about 11 μg mL⁻¹, about 0.5 μg mL⁻¹ to about 10 μg mL⁻¹, or about 0.5 μg mL⁻¹ to about 9 μg mL⁻¹.

In some embodiments, the MIC value is not affected by a presence of protein and/or salt in the aqueous medium.

In some embodiments, the compound of Formula (I), (II), (III) and (IV) are characterised by a IC₅₀ against mammalian cells of about 5 μg mL⁻¹ to about 256 μg mL⁻¹. In other embodiments, the IC₅₀ is about 5 μg mL⁻¹ to about 300 μg mL⁻¹, about 5 μg mL⁻¹ to about 280 μg mL⁻¹, about 5 μg mL⁻¹ to about 260 μg mL⁻¹, about 5 μg mL⁻¹ to about 250 μg mL⁻¹, about 5 μg mL⁻¹ to about 240 μg mL⁻¹, about 5 μg mL⁻¹ to about 220 μg mL⁻¹, about 5 μg mL⁻¹ to about 200 μg mL⁻¹, about 5 μg mL⁻¹ to about 180 μg mL⁻¹, about 5 μg mL⁻¹ to about 160 μg mL⁻¹, about 5 μg mL⁻¹ to about 140 μg mL⁻¹, about 5 μg mL⁻¹ to about 120 μg mL⁻¹, about 5 μg mL⁻¹ to about 100 μg mL⁻¹, about 5 μg mL⁻¹ to about 80 μg mL⁻¹, about 5 μg mL⁻¹ to about 60 μg mL⁻¹, about 5 μg mL⁻¹ to about 40 μg mL⁻¹, or about 5 μg mL⁻¹ to about 20 μg mL⁻¹.

In some embodiments, the compound of Formula (I), (II), (III) and (IV) are characterised by a selectivity index (IC₅₀/MIC) of about 2 to about 100. In other embodiments, the selectivity index is about 2 to about 90, about 2 to about 80, about 2 to about 70, about 2 to about 60, about 2 to about 50, about 2 to about 40, about 2 to about 30, about 2 to about 20, or about 2 to about 15.

In some embodiments, the compound of Formula (I), (II), (III) and (IV) are characterised by a minimum bactericidal concentration (MBC) of about 0.5 μg mL⁻¹ to 64 μg mL⁻¹. In other embodiments, the minimum inhibitory concentration (MIC) is about 0.5 μg mL⁻¹ to about 60 μg mL⁻¹, about 0.5 μg mL⁻¹ to about 55 μg mL⁻¹, about 0.5 μg mL⁻¹ to about 50 μg mL⁻¹, about 0.5 μg mL⁻¹ to about 45 μg mL⁻¹, about 0.5 μg mL⁻¹ to about 40 μg mL⁻¹, about 0.5 μg mL⁻¹ to about 35 μg mL⁻¹, or about 0.5 μg mL⁻¹ to about 30 μg mL⁻¹.

In some embodiments, the microbe does not develop a resistance after contact with the compound of Formula (I), (II), (III) and/or (IV). The resistance may not be significantly measurable.

In some embodiments, a bacterial membrane in a bacterial cell is depolarized after contact with the compound of Formula (I), (II), (III) and/or (IV).

The present disclosure also relates to a pharmaceutical composition, comprising a compound of Formula (I), (II), (III) and/or (IV) or a pharmaceutically acceptable salt, solvate or isomer thereof, and optionally in combination with a pharmaceutically acceptable excipient.

The present disclosure also relates to a composition, comprising a compound of Formula (I), (II), (III) and/or (IV) or a salt, solvate or isomer thereof, and optionally in combination with an excipient.

The present disclosure also relates to a method of treating a bacterial infection or disease, comprising administrating to a subject in need thereof a therapeutical effective amount of the compound of Formula (I), (II), (III) and/or (IV) or a pharmaceutically acceptable salt, solvate or isomer thereof.

The present disclosure also relates to a compound of Formula (I), (II), (III) and/or (IV) or a pharmaceutically acceptable salt, solvate or isomer thereof for use in treating a bacterial infection or disease.

The present disclosure also relates to use of a compound of Formula (I), (II), (III) and/oe (IV) or a pharmaceutically acceptable salt, solvate or isomer thereof in the manufacture of a medicament for treating a bacterial infection or disease.

In some embodiments, the compound of (I), (II), (III) and/or (IV) or a pharmaceutically acceptable salt, solvate or isomer thereof is provided to the subject in need thereof at about 0.05 mg/kg to about 10 mg/kg. In other embodiments, the concentration is about 0.05 mg/kg to about 9.5 mg/kg, about 0.05 mg/kg to about 9 mg/kg, about 0.05 mg/kg to about 8.5 mg/kg, about 0.05 mg/kg to about 8 mg/kg, about 0.05 mg/kg to about 7.5 mg/kg, about 0.05 mg/kg to about 7 mg/kg, about 0.05 mg/kg to about 6.5 mg/kg, about 0.05 mg/kg to about 6 mg/kg, about 0.05 mg/kg to about 5.5 mg/kg, about 0.05 mg/kg to about 5 mg/kg, about 0.05 mg/kg to about 4.5 mg/kg, about 0.05 mg/kg to about 4 mg/kg, about 0.05 mg/kg to about 3.5 mg/kg, or about 0.05 mg/kg to about 3 mg/kg.

In some embodiments, the bacterial in the bacterial infection or disease is an antibiotic resistant bacteria.

In some embodiments, the bacterial in the bacterial infection or disease is a Gram-negative bacterial or Gram-positive bacteria.

In some embodiments, the bacterial is selected from E. coli, P. aeruginosa, K. pneumonia, A. baumanii, S. aureus, Methicillin-resistant S. aureus, E. faecalis, E. facium, and non-tuberculous mycobacteria. In some embodiments, the bacterial is selected from Acetobacter aurantius, Acinetobacter baumannii, Actinomyces israelii, Agrobacterium radiobacter, Agrobacterium tumefaciens, Anaplasma, Anaplasma phagocytophilum, Azorhizobium caulinodans, Azotobacter vinelandii, viridans streptococci, Bacillus, Bacillus anthracis, Bacillus brevis, Bacillus cereus, Bacillus fusiformis, Bacillus licheniformis, Bacillus megaterium, Bacillus mycoides, Bacillus stearothermophilus, Bacillus subtilis, Bacillus thuringiensis, Bacteroides, Bacteroides fragilis, Bacteroides gingivalis, Bacteroides melaninogenicus (now known as Prevotella melaninogenica), Bartonella, Bartonella henselae, Bartonella quintana, Bordetella, Bordetella bronchiseptica, Bordetella pertussis, Borrelia burgdorferi, Brucella, Brucella abortus, Brucella melitensis, Brucella suis, Burkholderia, Burkholderia mallei, Burkholderia pseudomallei, Burkholderia cepacia, Calymmatobacterium granulomatis, Campylobacter, Campylobacter coli, Campylobacter fetus, Campylobacter jejuni, Campylobacter pylori, Chlamydia, Chlamydia trachomatis, Chlamydophila, Chlamydophila pneumoniae (previously called Chlamydia pneumoniae), Chlamydophila psittaci (previously called Chlamydia psittaci), Clostridium, Clostridium botulinum, Clostridium difficile, Clostridium perfringens (previously called Clostridium welchii), Clostridium tetani, Corynebacterium, Corynebacterium diphtheria, Corynebacterium fusiforme, Coxiella burnetii, Ehrlichia chaffeensis, Ehrlichia ewingii, Eikenella corrodens, Enterobacter cloacae, Enterococcus, Enterococcus avium, Enterococcus durans, Enterococcus faecalis, Enterococcus faecium, Enterococcus gallinarum, Enterococcus maloratus, Escherichia coli, Fusobacterium necrophorum, Fusobacterium nucleatum, Gardnerella vaginalis, Haemophilus, Haemophilus ducreyi, Haemophilus influenza, Haemophilus parainfluenzae, Haemophilus pertussis, Haemophilus vaginalis, Helicobacter pylori, Klebsiella pneumonia, Lactobacillus, Lactobacillus acidophilus, Lactobacillus bulgaricus, Lactobacillus casei, Lactococcus lactis, Legionella pneumophila, Leptospira interrogans, Leptospira noguchii, Listeria monocytogenes, Methanobacterium extorquens, Microbacterium multiforme, Micrococcus luteus, Moraxella catarrhalis, Mycobacterium, Mycobacterium avium, Mycobacterium bovis, Mycobacterium diphtheria, Mycobacterium intracellulare, Mycobacterium leprae, Mycobacterium lepraemurium, Mycobacterium phlei, Mycobacterium smegmatis, Mycobacterium tuberculosis, Mycoplasma, Mycoplasma fermentans, Mycoplasma genitalium, Mycoplasma hominis, Mycoplasma penetrans, Mycoplasma pneumonia, Mycoplasma Mexican, Neisseria, Neisseria gonorrhoeae, Neisseria meningitides, Pasteurella, Pasteurella multocida, Pasteurella tularensis, Peptostreptococcus, Porphyromonas gingivalis, Prevotella melaninogenica (previously called Bacteroides melaninogenicus), Pseudomonas aeruginosa, Rhizobium radiobacter, Rickettsia, Rickettsia prowazekii, Rickettsia psittaci, Rickettsia Quintana, Rickettsia rickettsia, Rickettsia trachomae, Rochalimaea, Rochalimaea henselae, Rochalimaea Quintana, Rothia dentocariosa, Salmonella, Salmonella enteritidis, Salmonella typhi, Salmonella typhimurium, Serratia marcescens, Shigella dysenteriae, Spirillum volutans, Staphylococcus, Staphylococcus aureus, Staphylococcus epidermidis, Stenotrophomonas maltophilia, Streptococcus, Streptococcus agalactiae, Streptococcus avium, Streptococcus bovis, Streptococcus cricetus, Streptococcus faecium, Streptococcus faecalis, Streptococcus ferus, Streptococcus gallinarum, Streptococcus lactis, Streptococcus mitior, Streptococcus mitis, Streptococcus mutans, Streptococcus oralis, Streptococcus pneumonia, Streptococcus pyogenes, Streptococcus rattus, Streptococcus salivarius, Streptococcus sanguis, Streptococcus sobrinus, Treponema, Ureaplasma urealyticum, Vibrio, Vibrio cholera, Vibrio comma, Vibrio parahaemolyticus, Vibrio vulnificus, Wolbachia, Yersinia, Yersinia enterocolitica, Yersinia pestis, and Yersinia pseudotuberculosis.

In some embodiments, the bacterial infection or disease is a bacteria skin infection. The bacteria skin infection may be, but not limited to, Cellulitis, Erysipelas, Folliculitis, Impetigo, Carbuncles, or Boils. In some embodiments, the bacterial infection or disease is a food-borne infection. The food-borne infection is an inflammation of the stomach and bowels and may lead to diarrhoea, nausea, vomiting, abdominal pain, abdominal cramps, chills and/or fever. In some embodiments, the bacterial infection or disease is selected from Brucellosis, Campylobacter infection, Cat-scratch disease, Cholera, Escherichia coli infection, Gonorrhea, Klebsiella, Enterobacter, and Serratia infection, Legionella infection, Meningococcal infection, Pertussis, Plague, Pseudomonas infection, Salmonella infection, Shigellosis, Typhoid fever, Tularemia, Anthrax, Clostridioides difficile-induced colitis, Diphtheria, Enterococcal infection, Erysipelothricosis, Listeriosis, Nocardiosis, Pneumococcal infection, Staphylococcal infection, Streptococcal infection, Bejel, yaws, and pinta, Leptospirosis, Lyme disease, Rat-bite fever, Relapsing fever, Syphilis, Tuberculosis, Actinomycosis, Bacteroides infection, Botulism, Clostridial infection, and Tetanus.

In some embodiments, the bacterial infection or disease is characterised by an antibiotic resistance. The antibiotic resistance may be to an antibiotic medication such as Vancomycin, Daptomycin, Ceftaroline, Linezolid, Ceftazidime, Aminoglycosides, Carbapenems, and/or Streptogramins.

In some embodiments, the compound of Formula (I), (II), (III) and/or (IV) or a pharmaceutically acceptable salt, solvate or isomer thereof is administered in combination with an antibiotic. The administration of the compound of Formula (I) or a pharmaceutically acceptable salt, solvate or isomer thereof and the antibiotic may be simultaneously or sequentially.

The present disclosure also relates to a method of disinfecting a surface, comprising contacting the compound of Formula (I), (II), (III) and/or (IV) with the surface.

In some embodiments, the surface is a non-biological surface.

The compound of the invention can be administered to a subject as a pharmaceutically acceptable salt thereof. Suitable pharmaceutically acceptable salts include, but are not limited to salts of pharmaceutically acceptable inorganic acids such as hydrochloric, sulphuric, phosphoric, nitric, carbonic, boric, sulfamic, and hydrobromic acids, or salts of pharmaceutically acceptable organic acids such as acetic, propionic, butyric, tartaric, maleic, hydroxymaleic, fumaric, maleic, citric, lactic, mucic, gluconic, benzoic, succinic, oxalic, phenylacetic, methanesulphonic, toluenesulphonic, benezenesulphonic, salicyclic sulphanilic, aspartic, glutamic, edetic, stearic, palmitic, oleic, lauric, pantothenic, tannic, ascorbic and valeric acids.

Base salts include, but are not limited to, those formed with pharmaceutically acceptable cations, such as sodium, potassium, lithium, calcium, magnesium, ammonium and alkylammonium. In particular, the present invention includes within its scope cationic salts eg sodium or potassium salts, or alkyl esters (eg methyl, ethyl) of the phosphate group.

It will be appreciated that any compound that is a prodrug of the compound of formula (I), (II), (III) and/or (IV) is also within the scope and spirit of the invention. Thus the compound of the invention can be administered to a subject in the form of a pharmaceutically acceptable pro-drug. The term “pro-drug” is used in its broadest sense and encompasses those derivatives that are converted in vivo to the compound of the invention. Such derivatives would readily occur to those skilled in the art. Other texts which generally describe prodrugs (and the preparation thereof) include: Design of Prodrugs, 1985, H. Bundgaard (Elsevier); The Practice of Medicinal Chemistry, 1996, Camille G. Wermuth et al., Chapter 31 (Academic Press); and A Textbook of Drug Design and Development, 1991, Bundgaard et al., Chapter 5, (Harwood Academic Publishers).

The compound of the invention may be in crystalline form either as the free compound or as a solvate (e.g. hydrate) and it is intended that both forms are within the scope of the present invention. Methods of solvation are generally known within the art.

The compound of the invention, or a pharmaceutically acceptable salt, solvate or prodrug thereof is administered to the patient in a therapeutically effective amount. As used herein, a therapeutically effective amount is intended to include at least partially attaining the desired effect, or delaying the onset of, or inhibiting the progression of, or halting or reversing the progression of bacterial diseases.

As used herein, the term “effective amount” relates to an amount of compound which, when administered according to a desired dosing regimen, provides the desired therapeutic activity. Dosing may occur at intervals of minutes, hours, days, weeks, months or years or continuously over any one of these periods. Suitable dosages may lie within the range of about 0.1 ng per kg of body weight to 1 g per kg of body weight per dosage, such as is in the range of 1 mg to 1 g per kg of body weight per dosage. In one embodiment, the dosage may be in the range of 1 mg to 500 mg per kg of body weight per dosage. In another embodiment, the dosage may be in the range of 1 mg to 250 mg per kg of body weight per dosage. In yet another embodiment, the dosage may be in the range of 1 mg to 100 mg per kg of body weight per dosage, such as up to 50 mg per body weight per dosage.

Suitable dosage amounts and dosing regimens can be determined by the attending physician and may depend on the severity of the condition as well as the general age, health and weight of the patient to be treated. Other factors including the activity of the specific compound employed, the age, body weight, general health, sex, diet, time of administration, rate of excretion, drug combination, and the judgment of the treating physician and the severity of the particular disease being treated. The amount of a compound of the present disclosure in the composition will also depend upon the particular compound in the composition.

The compound of the invention may be administered in a single dose or a series of doses. While it is possible for the active ingredient to be administered alone, it is preferable to present it as a composition, preferably as a pharmaceutical composition. The formulation of such compositions is well known to those skilled in the art. The composition may contain any suitable carriers, diluents or excipients. These include all conventional solvents, dispersion media, fillers, solid carriers, coatings, antifungal and antibacterial agents, dermal penetration agents, surfactants, isotonic and absorption agents and the like. It will be understood that the compositions of the invention may also include other supplementary physiologically active agents.

The carrier is pharmaceutically “acceptable” in the sense of being compatible with the other ingredients of the composition and not injurious to the patient. The compositions may conveniently be presented in unit dosage form and may be prepared by any methods well known in the art of pharmacy. Such methods include the step of bringing into association the active ingredient with the carrier which constitutes one or more accessory ingredients. In general, the compositions are prepared by uniformly and intimately bringing into association the active ingredient with liquid carriers or finely divided solid carriers or both, and then if necessary shaping the product.

Compositions as defined above may be administered orally, parenterally, by inhalation spray, topically, rectally, nasally, buccally, vaginally or via an implanted reservoir. The term “parenteral” as used herein includes subcutaneous, intravenous, intramuscular, intra-articular, intra-synovial, intrasternal, intrathecal, intrahepatic, intralesional and intracranial injection or infusion techniques. Preferably, the compositions are administered orally, intraperitoneally or intravenously. Sterile injectable forms of the compositions of this disclosure may be aqueous or oleaginous suspension. These suspensions may be formulated according to techniques known in the art using suitable dispersing or wetting agents and suspending agents. The sterile injectable preparation may also be a sterile injectable solution or suspension in a non-toxic parenterally acceptable diluent or solvent, for example as a solution in 1,3-butanediol. Among the acceptable vehicles and solvents that may be employed are water, Ringer's solution and isotonic sodium chloride solution. In addition, sterile, fixed oils are conventionally employed as a solvent or suspending medium.

For this purpose, any bland fixed oil may be employed including synthetic mono- or di-glycerides. Fatty acids, such as oleic acid and its glyceride derivatives are useful in the preparation of injectables, as are natural pharmaceutically-acceptable oils, such as olive oil or castor oil, especially in their polyoxyethylated versions. These oil solutions or suspensions may also contain a long-chain alcohol diluent or dispersant, such as carboxymethyl cellulose or similar dispersing agents that are commonly used in the formulation of pharmaceutically acceptable dosage forms including emulsions and suspensions. Other commonly used surfactants, such as Tweens, Spans and other emulsifying agents or bioavailability enhancers which are commonly used in the manufacture of pharmaceutically acceptable solid, liquid, or other dosage forms may also be used for the purposes of formulation.

Pharmaceutically acceptable compositions as defined above may be orally administered in any orally acceptable dosage form including, but not limited to, capsules, tablets, aqueous suspensions or solutions. In the case of tablets for oral use, carriers commonly used include lactose and corn starch. Lubricating agents, such as magnesium stearate, are also typically added. For oral administration in a capsule form, useful diluents include lactose and dried cornstarch. When aqueous suspensions are required for oral use, the active ingredient is combined with emulsifying and suspending agents. If desired, certain sweetening, flavoring or coloring agents may also be added.

Pharmaceutical compositions for parenteral injection may comprise pharmaceutically acceptable sterile aqueous or nonaqueous solutions, dispersions, suspensions or emulsions as well as sterile powders for reconstitution into sterile injectable solutions or dispersions just prior to use. Examples of suitable aqueous and nonaqueous carriers, diluents, solvents or vehicles include water, ethanol, polyols (such as glycerol, propylene glycol, polyethylene glycol, and the like), and suitable mixtures thereof, vegetable oils (such as olive oil), and injectable organic esters such as ethyl oleate. Proper fluidity may be maintained, for example, by the use of coating materials such as lecithin, by the maintenance of the required particle size in the case of dispersions, and by the use of surfactants.

These compositions may also contain adjuvants such as preservative, wetting agents, emulsifying agents, and dispersing agents. Prevention of the action of micro-organisms may be ensured by the inclusion of various antibacterial and antifungal agents, for example, paraben, chlorobutanol, phenol sorbic acid, and the like. It may also be desirable to include isotonic agents such as sugars, sodium chloride, and the like. Prolonged absorption of the injectable pharmaceutical form may be brought about by the inclusion of agents that delay absorption such as aluminium monostearate and gelatin.

If desired, and for more effective distribution, the compounds may be incorporated into slow release or targeted delivery systems such as polymer matrices, liposomes, and microspheres.

The injectable formulations may be sterilized, for example, by filtration through a bacterial-retaining filter, or by incorporating sterilizing agents in the form of sterile solid compositions that can be dissolved or dispersed in sterile water or other sterile injectable medium just prior to use.

Alternatively, pharmaceutically acceptable compositions as defined above may be administered in the form of suppositories for rectal administration. These can be prepared by mixing the agent with a suitable non-irritating excipient that is solid at room temperature but liquid at rectal temperature and therefore will melt in the rectum to release the drug. Such materials include cocoa butter, beeswax and polyethylene glycols.

Pharmaceutically acceptable compositions as defined above may also be administered topically, especially when the target of treatment includes areas or organs readily accessible by topical application, including diseases of the eye, the skin, or the lower intestinal tract. Suitable topical formulations may be readily prepared for each of these areas or organs.

Topical application for the lower intestinal tract may be effected in a rectal suppository formulation (see above) or in a suitable enema formulation. Topically-transdermal patches may also be used.

For topical applications, the pharmaceutically acceptable compositions may be formulated in a suitable ointment containing the active component suspended or dissolved in one or more carriers. Carriers for topical administration of compounds as defined above may include, but are not limited to, mineral oil, liquid petrolatum, white petrolatum, propylene glycol, polyoxyethylene, polyoxypropylene compound, emulsifying wax and water. Alternatively, the pharmaceutically acceptable compositions may be formulated in a suitable lotion or cream containing the active components suspended or dissolved in one or more pharmaceutically acceptable carriers. Suitable carriers may include, but are not limited to, mineral oil, sorbitan monostearate, polysorbate 60, cetyl esters wax, cetearyl alcohol, 2 octyldodecanol, benzyl alcohol and water.

For ophthalmic use, the pharmaceutically acceptable compositions may be formulated as micronized suspensions in isotonic, pH adjusted sterile saline, or, preferably, as solutions in isotonic, pH adjusted sterile saline, either with or without a preservative such as benzylalkonium chloride. Alternatively, for ophthalmic uses, the pharmaceutically acceptable compositions may be formulated in an ointment such as petrolatum.

Pharmaceutically acceptable compositions as defined above may also be administered by nasal aerosol or inhalation. Such compositions may be prepared according to techniques well-known in the art of pharmaceutical formulation and may be prepared as solutions in saline, employing benzyl alcohol or other suitable preservatives, absorption promoters to enhance bioavailability, fluorocarbons, and/or other conventional solubilizing or dispersing agents.

Most preferably, pharmaceutically acceptable compositions as defined above may be formulated for oral administration. Such formulations may be administered with or without food. In some embodiments, pharmaceutically acceptable compositions as defined above may be administered without food. In other embodiments, pharmaceutically acceptable compositions as defined above may be administered with food.

It should be understood that in addition to the active ingredients particularly mentioned above, the composition or combination of this invention may include other agents conventional in the art having regard to the type of composition or combination in question, for example, those suitable for oral administration may include such further agents as binders, sweeteners, thickeners, flavouring agents disintegrating agents, coating agents, preservatives, lubricants and/or time delay agents. Suitable sweeteners include sucrose, lactose, glucose, aspartame or saccharine. Suitable disintegrating agents include cornstarch, methylcellulose, polyvinylpyrrolidone, xanthan gum, bentonite, alginic acid or agar. Suitable flavouring agents include peppermint oil, oil of wintergreen, cherry, orange or raspberry flavouring. Suitable coating agents include polymers or copolymers of acrylic acid and/or methacrylic acid and/or their esters, waxes, fatty alcohols, zein, shellac or gluten. Suitable preservatives include sodium benzoate, vitamin E, alpha-tocopherol, ascorbic acid, methyl paraben, propyl paraben or sodium bisulphite. Suitable lubricants include magnesium stearate, stearic acid, sodium oleate, sodium chloride or talc. Suitable time delay agents include glyceryl monostearate or glyceryl distearate.

### Examples

### Synthesis and Characterization of Compounds

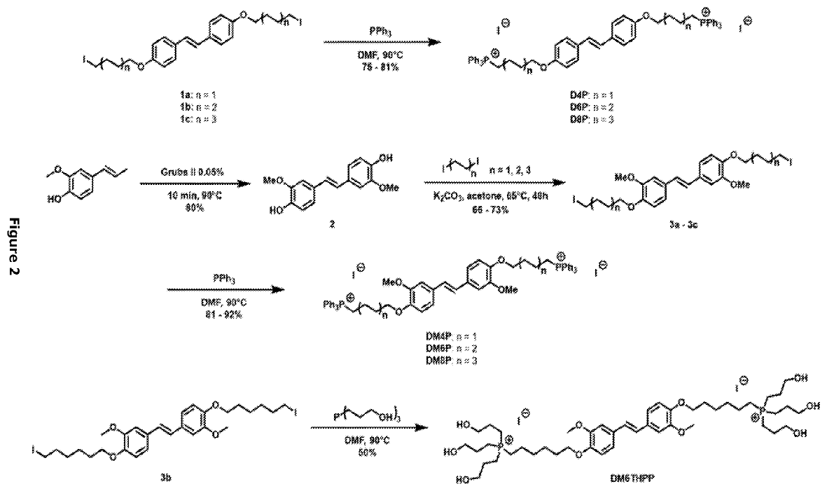

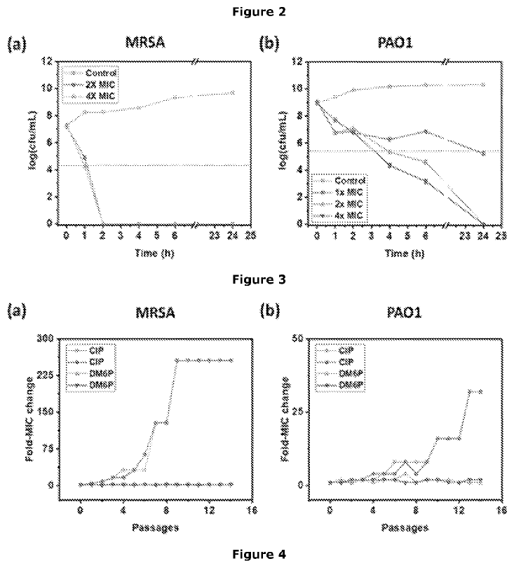

The synthetic entry into TPP-containing COEs builds on reaction of the corresponding neutral alkyl iodide precursors with triphenylphosphine in lieu of a tertiary amine, see FIG. 2. This approach is illustrated by the synthesis of D4P, D6P and D8P from previously reported 1a, 1b, and 1c, respectively. Olefin metathesis of commercially available isoeugenol furnished the necessary functionalized stilbene core 2 with excellent catalyst loading efficiency (0.05 mol %), highlighting the contributions of green synthetic efforts towards novel drug scaffolds. Compound 2 was alkylated with the corresponding α,ω-alkyldiiodide to give compounds 3a to 3c. The target TPP compounds were obtained by subsequent reactions of neutral intermediates with triphenylphosphine. Good yields were obtained following sequential recrystallizations in toluene and dichloromethane. Details for the synthesis and purification methods are provided below. The ease of synthetic diversification and relatively straightforward purification makes this class of compounds attractive for further derivatization.

Stepwise recrystallization of DM4P from N,N-dimethylformamide followed by dichloromethane also yielded high quality single crystals suitable for X-ray diffraction determination of its chemical structure. This study crystal revealed an inter-phosphorous distance of 2.1 Å and an overall molecular length of 3.3 Å, comparable to theoretically calculated values. These molecular dimensions, coupled with the hydrophobic driving forces, were anticipated to favour membrane intercalation.

Sufficient aqueous solubility of antibiotics is a crucial drug-like property to achieve good bioavailability, accurate drug concentrations and attain desired pharmacological responses. The solubility of all the TPP derivatives was determined in phosphate-buffered saline (PBS) (Table S3). Solubility generally decreases with increasing molecular length. Stilbene derivatives D4P, D6P, and DSP feature solubilities of 76, 18, and 4 μg mL⁻¹, respectively, with the measurements below 10 μg mL⁻¹ estimated through turbidimetric screening. In line with our design strategy, stilbene core functionalization resulted in an increase in the overall solubility. DM4P, the most soluble derivative, exhibits a solubility in PBS of 138 μg mL⁻¹, while values of 108 and 4 μg mL⁻¹ are observed for DM6P and DM8P, respectively. This difference can be reasonably attributed to the disruption in face-to-face stacking and an increase in overall total polar surface area of the molecule, while maintaining it below the estimated 140 Å² required to spontaneously insert into membranes.

### Activity Against a Broad Spectrum of Pathogens

Antimicrobial activity was screened against a range of pathogens made up of clinically relevant ESKAPE pathogens by determination of the minimum inhibitory concentration (MIC) in cation-adjusted Mueller-Hinton broth (CA-MHB). The results of these studies are provided in Table 1. Better antimicrobial activity was observed for the TPP-modified analogue D4P (4 μg mL⁻¹ towards S. aureus. and E. coli.) in contrast to D4 (>64 μg mL⁻¹ for both species). The increase in lipophilicity of the TPP group possibly compensated for the previously determined weak interactions with bacteria of D4. Slightly better activity was also observed for D6P towards Gram-positive SA strains (2 μg mL⁻¹), when compared to its TMA counterpart D6 (32 μg mL⁻¹). A further decrease in MIC to 1 μg mL⁻¹ was achieved in DM6P across all Gram-positive pathogens. Overall, these results indicate that TPP-analogues showed equal or better activity toward Gram-positive bacteria compared to their QA counterparts.

TABLE 1
MICs of lead COEs towards various ESKAPE pathogens. The highest
concentrations tested were 128 μg/mL for D4, polymyxin B, and vancomycin and 64
μg/mL for all other compounds. The maximum concentration testable for D8P and
DM8P was 4 μg/mL due to turbidity attributed to solubility reasons. EC = E. coli. K12
(ATCC 10798), PA = P. aeruginosa (ATCC47085), KP (CRE) = K. pneumoniae
(carbapenem-resistant Enterobacterales) (ATCC BAA1705), AB = A. baumanii (ATCC
17978), SA = S. aureus (ATCC 29213), MRSA = Methicillin-resistant S. aureus (ATCC
BAA1717), FAE = E. faecalis OG1RF (ATCC 47077), FAC = E. facium (ATCC 19434)

| | MIC (μg/mL) | | | | | | | |
|---|---|---|---|---|---|---|---|---|
| Compound | EC | PA | KP | AB | SA | MRSA | FAE | FAC |
| DM4P | 4 | 8 | 8 | 4 | 2 | 2 | 1 | 1 |
| DM6P | 2 | 4 | 8 | 8 | 1 | 1 | 1 | 1 |
| DM8P | >4 | >4 | >4 | >4 | >4 | 4 | 1 | 1 |
| D4P | 8 | 16 | 32 | 32 | 4 | 2 | 1 | 1 |
| D6P | 2 | 8 | >16 | >16 | 2 | 2 | 1 | 1 |
| D8P | >4 | >4 | >4 | >4 | >4 | >4 | 2 | 2 |
| D4 | 128 | >64 | >64 | >64 | >64 | >64 | 128 | 64 |
| D6 | 16 | >64 | >64 | >64 | 32 | 32 | 32 | 8 |
| D8 | 4 | >64 | 64 | 32 | 8 | 8 | 4 | 1 |
| DM6THPP | >64 | >64 | >64 | >64 | >64 | >64 | >64 | >64 |
| Polymyxin B | 1 | 2 | 2 | 4 | >128 | >128 | >128 | >128 |
| Vancomycin | >128 | >128 | >128 | >128 | 1 | 1 | 1 | 1 |

Note:
For DM8P and D8P, the molecule remains fully soluble at 4 μg/mL. At higher concentrations, accurate comparison becomes difficult due to precipitation.

Differences in activity conferred by the TPP group are more apparent against Gram-negative bacteria. For D6P, an MIC of 8 μg mL⁻¹ was observed towards P. aeruginosa, towards which the QA analogue D6 displayed an MIC >64 μg mL⁻¹. A further improvement in antimicrobial activity was observed for DM6P, which achieved MIC values of 4-8 μg mL⁻¹ against the WHO-critical Gram-negative pathogens A. baumanii, K. pneumoniae, and P. aeruginosa. Together, the two chemical modifications result in over a 16-fold improvement in antimicrobial activity. In contrast, the limited effectiveness of D8 solely towards E. coli. can be attributed to the more permeable membrane of E. coli. relative to other difficult-to-treat Gram-negative species such as Pseudomonas spp and Acinetobacter spp.

In general, changing the terminal group from trimethylalkylammonium to TPP improves the overall antimicrobial activity, most reasonably as a result of the overall increase in cation lipophilicity, while maintaining the dicationic nature of the molecule necessary for solubility and promoting association. However, as shown in Table 1, in contrast to observations from previous studies with D4, D6, and D8, an examination of the D4P to D8P analogs shows that increasing the length of the compound is not necessarily a straightforward means of lowering MIC. The lower dependency on molecular length hints at other potential membrane disruption mechanisms being relevant for biological activity compared to previously examined structures.

We also examined non-tuberculous mycobacteria (NTM). These are opportunistic pathogens that are rising in clinical significance due to their increasing prevalence and treatment difficulty. The membrane of Mycobacterium is inherently a greater antibiotic permeability barrier due to its high lipid content relative to other pathogens and long-tailed mycolic acids that contributed to its high lipophilic character. The antimicrobial activity of the TPP analogues were also evaluated against Mycobacterium in Middlebrook 7H9 broth. DM4P and DM6P featured MICs of 8 μg mL⁻¹ against M. abscessus clinical targets, comparable to values observed for antibiotics currently in use, namely amikacin and linezolid (Table 2). Activity towards this class of bacteria therefore shows possible avenues for the development of COEs as antibiotics to tackle challenging drug targets.

TABLE 2
MICs of TPP COEs against mycobacterium
M. abscesses (ATCC 19977).

| | MIC (μg/ml) |
|---|---|
| Compound | M. abscesses |
| DM4P | 8 |
| DM6P | 8 |
| DM8P | 64 |
| D4P | 32 |
| D6P | 16 |
| D8P | 128 |
| Amikacin | 8 |
| Linezolid | 8 |

To examine to what extent the antimicrobial activity of a COE-phosphonium derivative can be modulated through the chemical identity of the phosphonium fragment, we synthesized a more hydrophilic phosphonium variant, namely DM6THPP in FIG. 2, featuring pendant hydroxypropyl groups instead of the more hydrophobic phenyl substituent to aid in compound solubility. As expected, this compound is highly soluble in water (>2560 μg mL⁻¹). However, DM6THPP exhibited substantially reduced activity against pathogen strains tested (MIC >64 μg mL⁻¹, see Table 1), highlighting that the nature of the phosphonium functional group provides a relevant tuning structural factor to modulate antimicrobial action.

TPP Substitution does not Adversely Increase Cytotoxicity

The cytotoxicity of the TPP COEs was also tested against a mammalian cell line (A549). Replacement of the TMA group with TPP resulted in negligible change to the resulting IC₅₀ values (Table 3). A higher selectivity index (IC₅₀/MIC) of 11 for DM6P towards MRSA compared to A549 cells was achieved, compared to D8, which had similar antimicrobial activity but a IC₅₀/MIC of only 1.4 for the same cell line. Based on these results, we chose to focus on DM6P in the majority of subsequent studies that examine TPP-COE interactions with biological systems.

TABLE 3
IC₅₀ values against a mammalian cell line A549 (lung epithelial
cells). Selectivity index was determined based on the
IC50 of the divided by the MIC towards MRSA.

| | IC50 | | Selectivity |
|---|---|---|---|
| Compound | (ug mL⁻¹) | MIC | Index |
| DM4P | 9 | 2 | 4.5 |
| DM6P | 11 | 1 | 11.0 |
| DM8P | 10 | 4 | 2.5 |
| D4P | 8 | 2 | 4.0 |
| D6P | 13 | 2 | 6.5 |
| D8P | 7 | >4 | — |
| D4 | 548 | >64 | — |
| D6 | 39 | 32 | 1.2 |
| D8 | 11 | 8 | 1.4 |
| DM6THPP | >1024 | >64 | — |

### Antimicrobial Activity in Complex Environments

The complexities of the physiological environment often influence drug activity, particularly when cations in solution are implicated in their oligomerization-dependent mechanisms of action, such as for daptomycin. Binding of free drug to plasma proteins effectively reduces the available free concentration of the drug capable of killing bacteria, resulting in lower observable activity. We tested MIC values of DM4P and DM6P in the presence of human serum albumin (40 g L⁻¹) and high salt concentrations (Table 4). Under these conditions, the antimicrobial activity was minimally affected by these environmental factors, with MICs remaining within a 2-fold level.

TABLE 4
MICs of lead COEs in physiological-mimicking environments.
HSA = Human Serum Albumin

| | | MIC^{[a]} (μg mL⁻¹) | | | | |
|---|---|---|---|---|---|---|
| | Bacteria | — | HSA^{[b]} | NaCl^{[c]} | MgCl2^{[d]} | CaCl2^{[e]} |
| DM4P | SA | 2 | 2 | 4 | 2 | 2 |
| | PA | 8 | 8 | 4 | 8 | 8 |
| DM6P | SA | 1 | 1 | 1 | 1 | 1 |
| | PA | 4 | 8 | 8 | 4 | 4 |

^{[a]}MICs determined in MHB. Concentrations were ^{[b]}40 g L⁻¹, ^{[c]}300 mM, ^{[d]}1.25mM, and ^{[e]}1 mM respectively.

### TPP-COEs are Bactericidal

Determination of biological activity through MIC measurements does not discriminate between inhibition of bacterial replication or killing. To study the extent to which TPP-COEs can effectively kill bacteria, bacteria cells treated with DM6P at varying concentrations were plated onto Tryptic Soy Agar (TSA) and the minimum bactericidal concentration (MBC), where complete eradication of the inoculum occurred, was determined (Table 5). MBC values ranged from 2 μg mL⁻¹ towards MRSA to 8 μg mL⁻¹ towards PAO1 and stayed within a two to four-fold range of the MIC values for all strains tested.

TABLE 5
Minimum Bactericidal Concentrations (MBC)
of DM6P against various pathogens.

| Strain | MIC | MBC |
|---|---|---|
| EC | 2 | 2 |
| MRSA | 1 | 2 |
| CRKP | 8 | 16 |
| AB | 8 | 32 |
| PA | 4 | 8 |
| EF | 1 | 4 |

EC = E. coli. K12 (ATCC 10798), PA = P. aeruginosa (ATCC47085), KP (CRE) = K. pneumoniae (ATCC BAA1705), AB = A. baumanii (ATCC 17978), MRSA = Methicillin-resistant S. aureus (ATCC BAA1717), FAE = E. faecalis OG1RF (ATCC 47077)

Separately, MRSA and P. aeruginosa cultures were challenged with DM6P at varying concentrations and aliquots were taken at specific intervals to quantify the bacteria remaining. As shown in FIG. 3, nearly complete killing of MRSA (<100 cfu mL⁻¹) was observed within the first two hours at concentrations above the MBC value of 4 μg mL⁻¹. Against P. aeruginosa, a 99.95% (3.5 log) reduction in bacterial load was observed when treated at the MIC after 24 hours. Treatment at or above the MBC value resulted in eradication of the cells. Taken together, these results demonstrate that the TPP-derivatives retain the bactericidal activity characteristic of COEs.

### TPP-COEs Minimally Induce Resistance Development

The non-specific action of membrane-active antibiotics lends itself to minimal development of resistance development due to the large metabolic burden involved, unlike traditional antibiotics with a well-defined enzymatic target. Based on this premise, we passaged bacteria incubated with DM6P, or ciprofloxacin (control), at 0.5× MIC to investigate the adaptation of bacteria towards external antibiotic stress. As a control, treatment of MRSA with ciprofloxacin gave rise to antibiotic-resistant mutants within 4 passages, see FIG. 4a. FIG. 4b shows that this development occurred at a slower rate for P. aeruginosa. In comparison, DM6P did not induce any observable resistant mutants towards both bacteria strains under these experimental conditions. Combined with its broad spectrum of activity, this feature opens opportunities for the use of COE antimicrobial agents to address polymicrobial infections with a lower rate of emerging antibiotic resistance.

### Mechanistic Insights of Membrane Interactions of DM6P

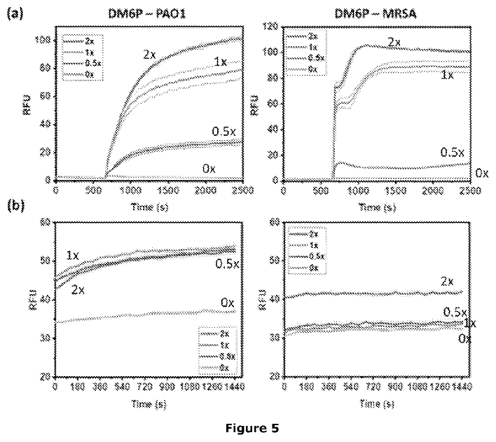

The interactions of DM6P with various bacterial cell membranes were first investigated through spectrometric methods. In normal cells, compartmentalization of the intracellular space by the lipid bilayer enables the maintenance of a transmembrane potential, which is necessary for regular cell division and energy production. The membrane-potential sensitive dye 3,3′-dipropylthiadicarbocyanine iodide (DiSC₃(5)) accumulates within the membranes of healthy, polarized cells where its fluorescence is self-quenched. Depolarization of the membrane necessary to maintain this gradient causes the release of this dye, resulting in an increase in fluorescence intensity. The treatment of DiSC₃(5)-encapsulated MRSA and PAO1 cells with DM6P showed a dose-dependent depolarization of the bacterial membrane upon association of the molecules, indicative of COE-induced ion leakage (FIG. 5a). Even at half-MIC levels, interactions of the compound with the cell membrane appear to induce ion efflux.

Another hallmark of cytoplasmic membrane damage is an enhanced permeability towards small molecules. Propidium iodide (PI) is a membrane-impermeant organic dye that can be used to study potential mechanisms of action of antibiotics due to its enhanced fluorescence intensity upon binding to intracellular DNA. Treatment with molecules that cause membrane perturbations enable rapid influx of the dye, resulting in an increase in fluorescence emission that can be monitored over time. When MRSA and PAO1 were treated with DM6P at concentrations ranging from half to twice the MIC (0.5 to 2 μg mL⁻¹ against MRSA, and 2 to 8 μg mL⁻¹ against PA), an increase in emission intensity from the propidium cation was observed (FIG. 5b). For treated PAO1 cells, the increase in PI influx appeared to be independent of concentration. In the case of treated MRSA cells, PI influx was observed at 2×MIC, corresponding to the bactericidal concentration of DM6P. This difference hints at two plausible mechanisms of action that are concentration dependent. Similar observations have been made for tobramycin, where a protein inhibition mode of action at lower concentrations (<4 μg mL⁻¹) is supplanted by disruption of the outer membrane at higher concentrations (8 μg mL⁻¹).

Flow cytometry measurements were carried out to quantify PI uptake at the cellular level. Suspensions of PAO1 were treated with DM6P at 16 μg mL⁻¹ (4× MIC) followed by staining with PI for 15 minutes, a duration where most of the dye was observed to have been taken up by the cells. Compared to the buffer-administered control groups, treatment with COEs at bactericidal concentrations showed near quantitative cell staining with PI. The heat-killed control population showed similar fluorescence intensities as compared to COE-treated samples, consistent with DM6P increasing membrane disorder.

### Visualization of COE-Induced Membrane Damage

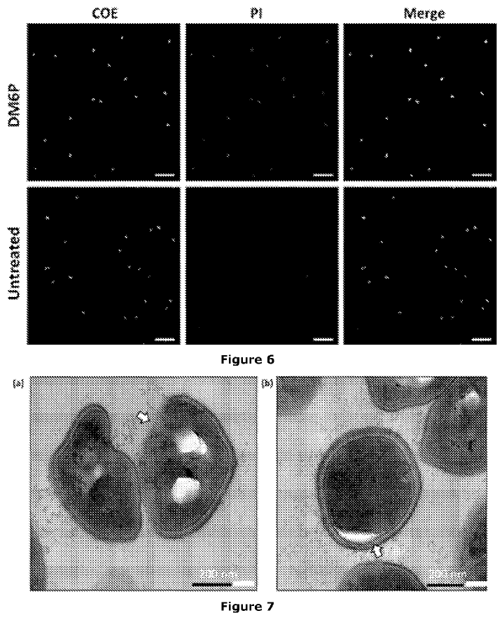

Membrane damage induced by COE treatment was also confirmed by fluorescence microscopy. A combination of SYTO-9 and PI is commonly employed as a live-dead stain to distinguish cells with permeabilized membranes. SYTO-9 accumulates within both healthy and dead cells and exhibits strong fluorescence when bound to nucleic acids. Combined with PI, the contrast between the colours is employed as a visual indicator of membrane damage. PAO1 cells exposed to 16 μg mL⁻¹ of DM6P for 30 minutes were subsequently stained with both dyes and imaged directly. In line with previous assays, only the COE-treated sample was observed to have clear staining by PI in the red fluorescence channel in FIG. 6, reflecting a compromised inner membrane.

Damage to the bacterial cell membrane was observed by transmission electron microscopy (TEM). S. aureus cells were incubated with DM6P at 4 μg mL⁻¹ for 30 minutes and fixed immediately to preserve the membrane ultrastructure as close to the point of cell death as possible. As showed in FIGS. 7a and 7b, untreated MRSA controls showed smooth, well-aligned cell walls with no signs of morphological damage. DM6P treatment resulted in visible cellular shrinkage and membrane disintegration, shown in regions highlighted by the white arrows in FIG. 7c. Sections of the cell wall and cytoplasmic membrane, clearly observable as thick grey lines were found to be absent. In FIG. 7d, cytoplasmic membrane separation, which is a key hallmark of plasmolysis was also observed in a cell, presumably in an earlier stage of death prior to leakage of intracellular components. These observations are consistent with micrographs from cells treated by membrane active AMPs Gramicidin S and PGLa. Taken together, these morphological features are in line with the central idea that TPP-COEs induce damage to the cellular membrane, similar to previously studied COEs. Cellular leakage, protein delocalization and inactivation, and small-molecule permeation are downstream observations frequently associated with cell membrane perturbations.

### In Vivo Studies

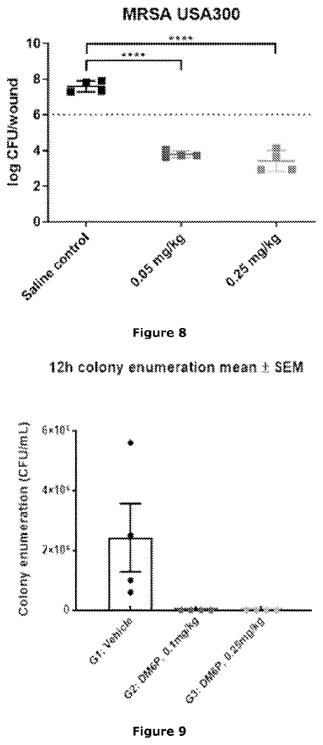

To probe the potential of TPP-COEs as viable therapeutics, we assessed the efficacy of DM6P to treat bacterial infections in vivo. An S. aureus murine wound infection model was used due to prevalent clinical concerns associated with S. aureus skin and soft tissue infections (SSTIs). As shown in FIG. 8, treatment of mice inoculated with MRSA with a dosage of either 0.05 and 0.25 mg/kg of DM6P showed a 3.8 and 4.2-log fold reduction (over 99.99% at 0.25 mg/kg) in bacterial load compared to the saline-treated group. Relative to current clinical dosages of 4-6 mg/kg for daptomycin, the low concentrations required to achieve such activity in vivo and absence of bacterial regrowth after 24 hours underscores the potential for further developing TPP-COEs with improved activity and safety profiles.

The physiological compatibility of DM6P was assessed through measurement of blood biomarker levels of mice from blood samples after 14 days of treatment at the highest concentration of 0.25 mg/kg. We evaluated common biomarkers such as total protein content (TP), albumin (ALB), globulin (GLO), total bilirubin (TBIL), alanine aminotransferase (ALT), aspartate aminotransferase (AST), gamma-glutamyl transferase (GGT), blood urea nitrogen (BUN), and creatinine (CRE), and found no significant difference in protein levels or enzymatic activity compared to saline-treated controls (Table 6). Hematoxylin-Eosin (H&E) staining of the major organs of DM6P treated mice also did not reveal any abnormal signs nor did it impede wound healing.

TABLE 6
Blood biomarker levels of mice treated with either
0.9% saline (control) or DM6P (0.25 mg kg⁻¹).

| Blood | | DM6P | Standard |
|---|---|---|---|
| Biomarker | Control | Treated | Range |
| TP (g/L) | 51.3 ± 0.9 | 48.6 ± 1.9 | 33-66 |
| ALB (g/L) | 32.7 ± 1.8 | 30 ± 3.3 | 25-48 |
| GLO (g/L) | 18.5 ± 2.3 | 18.6 ± 1.5 | 5-40 |
| TBIL (μM) | 4.1 ± 1.3 | 2.9 ± 0.5 | 1.7-15.4 |
| ALT (U/L) | 51 ± 21.3 | 38.7 ± 4.1 | 28-132 |
| AST (U/L) | 208 ± 74.5 | 205 ± 50.7 | 59-247 |
| GGT (U/L) | 1.4 ± 0.7 | 0.6 ± 0.1 | 1-15 |
| BUN (mM) | 6 ± 0.4 | 6.7 ± 0.3 | 4.9-10.4 |
| CRE (μM) | 53.3 ± 20.1 | 63.7 ± 10.1 | 26-88 |

Data presented as mean ± s.d. (n = 3).
Standard ranges were taken from a veterinary database (MNChip, Tianjin).
TP = Total protein, ALB = Albumin, GLO = Globulin, TBIL = Total bilirubin, ALT = Alanine transaminase, AST = Aspartate aminotransferase, GGT = Gamma-glutamyl transferase, BUN = Blood urea nitrogen, CRE = Creatine.

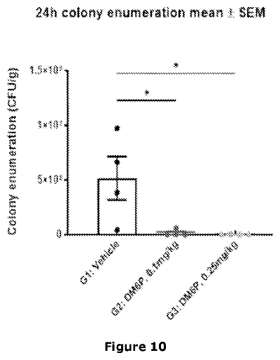

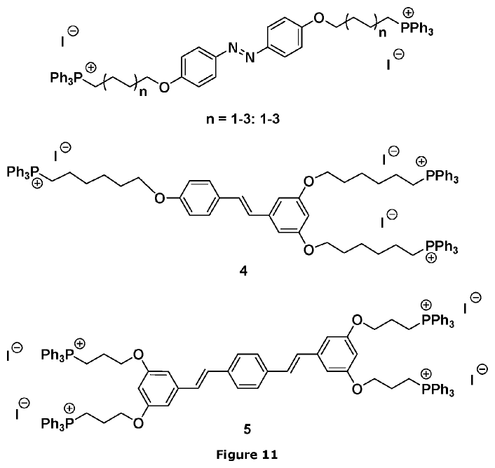

Staphylococcus pseudintermedius (SP) is particularly pathogenic towards dogs, with skin infections such as pyoderma being characterized by a lengthy treatment period and high treatment failure due to antimicrobial resistance. Here, we show high in vivo antimicrobial efficacy of compounds of FIG. 11 in a mouse wound infection model, featuring over a 3-log reduction in bacterial load at low concentrations. The 12 h and 24 h colony enumerations are shown in FIGS. 9 and 10. The grouping tested with saline has an average CFU of 5.16×10⁸ CFU/g. The grouping tested with DM6P (0.1 mg/kg) has an average CFU of 1.62×10⁷ CFU/g. The grouping tested with DM6P (0.25 mg/kg) has an average CFU of 5.51×10⁵ CFU/g. Furthermore, following compound administration, the mice did not show any negative side effects, indicating tolerability.

TABLE 7
MIC values for compounds 1-5 (FIG. 11) against methicillin-resistant
S. aureus (USA300) and E. coli K12 (ATCC 10798)

| Compound | MRSA | E. coli K12 |
|---|---|---|
| 1 | 2 | 8 |
| 2 | 2 | 4 |
| 3 | 4 | 32 |
| 4 | 4 | 32 |
| 5 | 32 | 64 |

### CONCLUSIONS

A series of COEs bearing lipophilic TPP groups was synthesized to understand how this cationic functional group impacts antibiotic activity, relative to the more frequently studied quaternary ammonium counterparts. It was shown that substitution of the cationic centre from TMA to TPP enabled broad-spectrum activity towards the ESKAPE panel as well as Mycobacterium, and remained unaffected in complex physiological mimicking environments. Optimal activity towards bacteria was obtained for DM6P through careful maintenance of the hydrophobic-hydrophilic balance of the overall molecule. Additionally, this TPP substitution does not compromise the cytotoxicity and retained the membrane-perturbing properties characteristic of previously studied COEs. Importantly, DM6P proved effective at treating MRSA skin infections based on a murine wound model, even at a dose of 0.05 mg kg⁻¹. This in vivo efficacy was further verified in a S. pseudintermedius infection. These findings further demonstrate a straightforward molecular design principle to broaden the spectrum of activity of antimicrobial stilbene derived COEs.

### Synthetic Protocols and Methods

### (E)-4,4′-(ethene-1,2-diyl)bis(2-methoxyphenol) (2)

Compound 1 was synthesized according to a modified literature procedure.² In a 250 mL round-bottom flask equipped with a magnetic stir-bar, 2-Methoxy-4-propenylphenol (0.5 g, 1.0 eq.), and Grubbs II catalyst (1 mg) were added in a glovebox. The flask was capped with a septum, evacuated, and placed under positive nitrogen flow. The reaction mixture was then heated to 90° C. and stirred for 10 minutes, during which the mixture quickly solidified. The crude product was then suspended in dichloromethane (2 mL) and methanol (3 mL), and stirred for 30 minutes. The resulting suspension was left to sit to 0° C. for another 30 minutes, filtered, and washed with cold methanol until the filtrate was colorless. The resulting solids were dried under vacuum to afford the pure compound 2. 1H NMR (400 MHz, DMSO-d6) δ 9.02 (s, 2H), 7.13 (d, J=2.0 Hz, 2H), 6.96-6.90 (m, 4H), 6.74 (d, J=8.1 Hz, 2H), 3.82 (s, 6H).

### General Procedure for Alkylation of Compound 2.

In a 250 mL round-bottom flask equipped with a magnetic stir-bar, compound 2 (0.5 g, 1.0 eq.), potassium carbonate (3 eq.), and the corresponding α,ω-diiodoalkane (6 eq.) were dissolved in acetone under an inert atmosphere. The reaction mixture was heated to reflux for 48 hours. After cooling to room temperature, the reaction mixture was concentrated under reduced pressure, diluted with dichloromethane and washed with water (200 mL×3) and brine (200 mL). The organic fraction was dried over sodium sulfate, filtered, and the solvents were removed in vacuo. The crude product was purified using column chromatography (silica, hexane/DCM 1:2 eluent) to give the desired pure product.

### (E)-1,2-bis(4-(4-iodobutoxy)-3-methoxyphenyl) ethene (3a)

1,4-diiodobutane was used, and the product was obtained as a white solid (73% yield). 1H NMR (400 MHz, Chloroform-d) δ 7.09-7.02 (m, 2H), 6.94 (s, 1H), 6.87 (d, J=8.3 Hz, 1H), 4.08 (t, J=6.2 Hz, 2H), 3.95 (s, 3H), 3.31 (t, J=6.8 Hz, 2H), 2.13-2.04 (m, 2H), 1.99 (d, J=8.3 Hz, 2H). 13C NMR (101 MHz, CDCl3) δ 149.66, 148.04, 131.03, 126.74, 119.54, 113.31, 109.27, 67.94, 56.01, 30.22, 30.14, 6.45.

### (E)-1,2-bis(4-((6-iodohexyl)oxy)-3-methoxyphenyl) ethene (3b)

1,6-diiodohexane was used, and the product was obtained as a white solid (70% yield). 1H NMR (400 MHz, Chloroform-d) δ 7.08 (d, J=2.0 Hz, 1H), 7.06-7.01 (m, 1H), 6.94 (s, 1H), 6.88 (d, J=8.3 Hz, 1H), 4.06 (t, J=6.7 Hz, 2H), 3.95 (s, 3H), 3.23 (t, J=7.0 Hz, 2H), 1.89 (s, 4H), 1.55-1.47 (m, 4H).

### (E)-1,2-bis(4-((8-iodooctyl)oxy)-3-methoxyphenyl) ethene (3c)

1,8-diiodooctane was used, and the product was obtained as a white solid (66% yield). 1H NMR (400 MHz, Chloroform-d) δ 7.05 (d, J=2.0 Hz, 1H), 7.01 (dd, J=8.3, 2.0 Hz, 1H), 6.91 (s, 1H), 6.85 (d, J=8.3 Hz, 1H), 4.03 (t, J=6.8 Hz, 2H), 3.19 (t, J=7.0 Hz, 2H), 1.89-1.78 (m, 4H), 1.49-1.30 (m, 8H).

### General Procedure for the Quaternization of COEs (A)

A screw-capped vial was charged with compound 1 (1.0 eq.) and PPh₃ (2.5 eq.), and purged with N₂. The reagents were dissolved in 2 mL of DMF and heated to 90° C. After stirring for 48 hours, the reaction mixture was cooled to room temperature and toluene (ca. 10 mL) was layered on top. The flask was placed in the fridge overnight and the white solids were collected via filtration and washed extensively with diethyl ether. The crude solids were redissolved in DMF and triturated with diethyl ether to obtain the pure compounds.

### General Procedure for the Quaternization of COEs (B)

A screw-capped vial was charged with compound 1 (1.0 eq.) and tris(hydroxylpropyl)phosphine (3 eq.), and purged with N₂. The reagents were dissolved in 2 mL of DMF and heated to 90° C. After stirring for 48 hours, the reaction mixture was cooled to room temperature and 40 ml of diethyl ether was added to precipitate the product as an oily residue. The product was washed with toluene and diethyl ether and redissolved in a minimum amount of DMF. The solution was triturated twice with diethyl ether and dried under high vacuum to give the product as a gummy white solid (50% yield).

### General Procedure for the Quaternization of COEs (C)

A screw-capped vial was charged with compound 1 and dissolved in 1 mL of DMF at 45° C. A solution of trimethylamine in THF (0.5 mL, 3.2 M) was added in one portion and the reaction was stirred for 48 hours. Solvents were removed under reduced pressure and the resulting residue was dissolved in a minimum amount of methanol. Pure compounds were obtained through trituration with diethyl ether.

### DM4P

The reaction was carried out through general procedure A. The product was obtained as a white solid in 92% yield.

1H NMR (400 MHz, Chloroform-d) δ 7.78 (s, 9H), 7.70-7.62 (m, 6H), 7.03-6.97 (m, 2H), 6.90 (d, J=1.6 Hz, 1H), 6.85 (d, J=8.3 Hz, 1H), 4.12 (t, J=5.5 Hz, 2H), 3.83 (d, J=3.4 Hz, 2H), 3.69 (s, 3H), 2.21 (s, 2H), 1.93 (d, J=7.9 Hz, 2H). 13C NMR (101 MHz, Chloroform-d) δ 134.92, 134.89, 133.60, 133.50, 130.30, 130.18, 126.30, 119.40, 118.89, 118.04, 113.08, 109.21, 67.04, 55.51, 39.50, 18.80. 31P NMR (162 MHz, CDCl3) δ 24.34 ESI-MS (TOF): [(M−2I)²⁺] 453.6

### DM6P

The reaction was carried out through general procedure A. The product was obtained as a white solid in 86% yield.

1H NMR (400 MHz, DMSO-d6) δ 7.95-7.74 (m, 15H), 7.18 (d, J=2.0 Hz, 1H), 7.07-7.00 (m, 2H), 6.90 (d, J=8.4 Hz, 1H), 3.92 (t, J=6.4 Hz, 2H), 3.79 (s, 3H), 3.58 (s, 2H), 1.67 (s, 2H), 1.55 (s, 4H), 1.44 (s, 2H). 13C NMR (101 MHz, DMSO-d6) δ 134.89, 134.86, 133.62, 133.52, 130.29, 130.16, 126.24, 119.39, 118.97, 118.12, 112.97, 109.15, 67.96, 55.48, 39.50, 28.40, 24.70, 21.72, 19.91. 31P NMR (162 MHz, DMSO-d6) δ 24.04. ESI-MS (TOF): [(M−2I)²⁺] 481.6

### DM8P

The reaction was carried out through general procedure A. The product was obtained as a white solid in 82% yield.

1H NMR (400 MHz, DMSO-d6) δ 7.78 (d, J=1.1 Hz, 15H), 7.19 (d, J=1.9 Hz, 1H), 7.03 (d, J=6.7 Hz, 2H), 6.91 (d, J=8.4 Hz, 1H), 3.92 (t, J=6.5 Hz, 2H), 3.80 (s, 3H), 3.56 (s, 2H), 1.68 (s, 2H), 1.38 (d, J=70.8 Hz, 10H). 13C NMR (126 MHz, DMSO-d6) δ 134.48, 134.45, 133.20, 133.12, 129.88, 129.78, 126.14, 119.16, 118.63, 117.95, 113.68, 110.05, 68.36, 55.62, 28.41, 27.96, 27.57, 24.97, 21.41, 20.53, 20.13. 31P NMR (162 MHz, DMSO-d6) δ 24.08. ESI-MS (TOF): [(M−2I)²⁺] 509.7

### D4P

The reaction was carried out through general procedure A. The product was obtained as a white solid in 75% yield.

1H NMR (400 MHz, Chloroform-d) δ 7.71 (d, J=1.6 Hz, 9H), 7.64-7.57 (m, 6H), 7.32-7.27 (m, 2H), 6.80 (s, 1H), 6.73 (d, J=8.8 Hz, 2H), 4.03 (t, J=5.6 Hz, 2H), 3.78 (d, J=3.5 Hz, 2H), 2.19-2.11 (m, 2H), 1.81 (d, J=7.8 Hz, 2H). 31P NMR (162 MHz, DMSO-d6) δ 24.08. 13C NMR (101 MHz, DMSO-d6) δ 158.27, 135.43, 135.40, 134.13, 134.03, 130.80, 130.68, 127.87, 126.26, 119.39, 118.54, 115.18, 66.47, 29.75, 29.58, 20.45, 19.95, 18.98, 18.95. ESI-MS (TOF): [(M−2I)²⁺] 423.6

### D6P

The reaction was carried out through general procedure A. The product was obtained as a white solid in 77% yield.

1H NMR (400 MHz, Chloroform-d) δ 7.88-7.79 (m, 10H), 7.73 (s, 6H), 7.38 (d, J=8.8 Hz, 2H), 6.89 (s, 1H), 6.85 (d, J=8.8 Hz, 2H), 3.96 (t, J=6.3 Hz, 2H), 3.74 (d, J=3.0 Hz, 2H), 1.75 (d, J=2.4 Hz, 6H), 1.51 (s, 2H). 13C NMR (101 MHz, DMSO-d6) δ 158.47, 135.39, 135.36, 134.13, 134.03, 130.79, 130.67, 130.39, 127.88, 126.20, 119.47, 118.62, 115.08, 67.75, 36.27, 30.14, 29.97, 28.82, 25.23, 22.24, 22.20, 20.91, 20.41. 31P NMR (162 MHz, DMSO-d6) δ 24.05. ESI-MS (TOF): [(M−2I)²⁺] 451.6

### D8P

The reaction was carried out through general procedure A. The product was obtained as a white solid in 81% yield.

1H NMR (400 MHz, Chloroform-d) δ 7.82 (s, 9H), 7.73 (d, J=2.8 Hz, 6H), 7.40 (d, J=8.9 Hz, 2H), 6.91 (s, 1H), 6.87 (d, J=8.8 Hz, 2H), 3.95 (t, J=6.5 Hz, 2H), 3.72 (s, 2H), 1.68 (s, 5H), 1.53-1.22 (m, 8H). 13C NMR (126 MHz, DMSO-d6) δ 134.47, 133.21, 133.13, 129.89, 129.79, 129.74, 127.02, 125.58, 117.96, 114.47, 67.34, 39.50, 28.27, 27.97, 27.57, 24.96, 21.42, 20.53, 20.13. ESI-MS (TOF): [(M−2I)²⁺] 479.7

### DM6THPP

The reaction was carried out through general procedure B. The product was obtained as a white solid in 50% yield.

1H NMR (400 MHz, DMSO-d6) δ 7.20 (d, J=1.9 Hz, 2H), 7.10-7.01 (m, 4H), 6.94 (d, J=8.5 Hz, 2H), 4.80 (t, J=5.0 Hz, 6H), 3.97 (t, J=6.4 Hz, 4H), 3.82 (s, 6H), 3.48 (q, J=5.7 Hz, 12H), 2.25 (d, J=3.3 Hz, 16H), 1.66 (s, 16H), 1.47 (s, 12H).

### Single-Crystal Growth and Measurements

X-ray quality single crystals were growth by slow diffusion of hexane into a solution of DM4P dissolved in dichloromethane. Single crystal X-ray diffraction data was collected using a Bruker D8 Advance Diffractometer at 100 K. The frames were integrated with the Bruker SAINT software package using a narrow-frame algorithm. The structure was solved and refined using the Bruker SHELXTL Software Package, using the space group P −1, with Z=1 for the formula unit, C₆₀H₆₀O₄P₂I₂·CHCl₂. The final anisotropic full-matrix least-squares refinement on F2 with 363 variables converged at R1=3.65%, for the observed data and wR2=9.92% for all data.

### Minimum Inhibitory Concentration Determination

Minimum inhibitory concentrations of COEs were determined through a broth microdilution method in accordance with the Clinical and Laboratory Standards Institute (CLSI) guidelines M07-A10. A single bacterial colony was isolated from an overnight culture and grown to mid-log phase (OD₆₀₀~0.8). Compounds were prepared as a stock solution in DMSO and diluted in a sterile flat-bottom 96-well plate in CA-MHB. Subsequent concentrations were prepared by two-fold dilution of the initial solution. An equivalent volume of bacteria was added to the compound to a final concentration of 5×10⁵ cfu/mL. Plates were incubated at 37° C. for 16-18 hours, and read at OD₆₀₀ using a microplate reader (TECAN Spark®). MIC₉₀ values were determined from the concentration at which less than 10% of bacteria growth was observed compared to the corresponding controls. MIC values were determined for each compound in triplicate. For each test, Polymyxin B (Gram-negative) or vancomycin (Gram-positive) was used as a positive control.

### Minimum Bactericidal Concentration (MBC) Determination

Bacteria samples treated with DM6P at varying concentrations from a broth microdilution method in a 96-well plate according to the methods for determining the MIC. Colonies were plated on TSB agar plates with 20 μL inoculation and the plates incubated at 37° C. overnight. The MBC was determined to be the COE concentration at which no colonies were observed to have grown. All measurements were performed in triplicate.

### Time-Kill Kinetics

The time-kill kinetics was determined against Pseudomonas aeruginosa (PAO1, ATCC 47085) and methicillin-resistant Staphylococcus aureus (ATCC BAA-1717). Bacteria tested were subcultured in Cation-Adjusted Mueller Hinton II Broth (CAMHB, BD Biosciences) from overnight cultures to mid-log phase at 37° C. with shaking at 200 rpm and diluted to an OD₆₀₀ value of 0.2 and aliquoted into 2 mL fractions in culture tubes. The resulting bacterial suspension was then challenged with DM6P at varying concentrations and incubated at 37° C. with shaking at 200 rpm. At regular intervals, 100 μL aliquots of each sample were diluted with 10-fold dilution in PBS and plated on TSB agar plates with 100 μL inoculation. The colonies were incubated at 37° C. overnight and counted to determine the cfu/mL of each sample. Experiments were performed in triplicate.

### Membrane Depolarization Assay

Determination of the extent of depolarization of bacterial cell membranes was carried out using a voltage sensitive dye DiSC₃(5) (ThermoFisher, USA). The dye is able to accumulate within polarized healthy cell membranes with resulting quenched fluorescence. When the membrane is depolarized, subsequent ion permeabilization releases the dye from the membrane and gives rise to enhanced fluorescence intensity.³ The assay was performed according to a modified protocol reported previously. Briefly, the corresponding bacteria was collected from mid-log cultures by centrifugation (7000 rpm, 10 minutes) and washed thrice with PBS containing 200 mM glucose. The pellet was then resuspended in the same buffer and diluted to an optical density of 0.3. The probe was then added to this suspension to a final concentration of 1 μM and seeded in a 96-well plate at 100 μl per well. The plate was incubated in the dark for 30 minutes, with the signal measured every 5 minutes until a stable baseline was observed. COEs were then added at varying concentrations and the fluorescence intensity was measured over time at 37° C. Excitation and emission wavelengths used were 600 nm and 660 nm respectively. Quantitative membrane depolarization was induced by treating the cells with 0.2% (v/v) Triton-X-100 to completely lyse the cells as a positive control. Separate wells containing untreated cells were used as a negative control. No interactions between the probe and the compound was observed in the absence of bacteria. Data was plotted as the mean±SEM for two experiments carried out with triplicates.

### Propidium Iodide Influx Assay

The assay was performed according to a modified reported protocol.⁴ Briefly, the corresponding bacteria was collected from mid-log cultures by centrifugation (7000 rpm, 10 minutes) and washed thrice with PBS. The pellet was then resuspended in the same buffer and diluted to an optical density of 2 by extrapolation. Cells were treated with the COE at the desired final concentrations (100 □L) in a 96-well plate and incubated in the dark for 30 minutes. An equal volume of propidium iodide (PI) was added to the wells and mixed (final concentration 30 μM). Fluorescence intensity was measured over time in a plate reader with an excitation wavelength of 525 nm and emission wavelength of 620 nm. Fluorescence signals were measured every 30 seconds and carried out in triplicate.

### Live-Dead Staining

Cell membrane integrity was determined using LIVE/DEAD™ BacLight™ bacterial viability kit L7007 (ThermoFisher, USA) according to the manufacturer's protocol. Bacteria cells were collected from mid-log cultures by centrifugation (7000 rpm, 10 minutes). The media was removed, and the bacteria was washed with PBS twice and diluted to a concentration of about 1×10⁷ CFU per mL. The bacterial suspension was treated with DM6P to a final concentration of 2×MIC and incubated at 37° C. for 2 hours with shaking at 200 rpm. A mixture of the dyes SYTO-9 and PI dissolved in DMSO were added to the suspension at final concentrations of 5 μM and 30 μM respectively. The bacteria were then incubated in the dark for 15 min. Samples were prepared by aliquoting 5 μl onto a clean glass slide, trapped with an 18 mm coverslip and imaged on an epifluorescence microscope (Leica Thunder Imager).

### Transmission Electron Microscopy

A mid-log culture of MRSA was treated either with DM6P at 4 Ig mL⁻¹ or PBS (control) and incubated for 30 minutes. Cells were then fixed with 4% glutaraldehyde at 4° C. overnight and collected by centrifugation (7000 rpm, 10 minutes). The cell pellets were post-fixed with 0.2% OsO₄, serially dehydrated in a graded ethanol series, and embedded in an epoxy resin. Ultrathin slices were stained with uranyl acetate, mounted onto a copper grid and imaged on a JEOL JEM-1400Flash TEM.

### Flow Cytometry

Bacteria cells were collected from mid-log cultures by centrifugation (7000 rpm, 10 minutes). and washed with PBS twice. Cells were treated with the COE at 4×MIC and incubated for 30 minutes. PI (30 μM, final concentration) was then added and the cells were further incubated for 10 minutes. The suspension was then diluted in PBS to an appropriate cell density and analysed with flow cytometry using an Amnis ImageStreamX Mk II Imaging Flow Cytometer. The collection gate was set using the area vs aspect ratio of the brightfield channel to select for intact cell events only. To select for PI-stained cells, excitation was carried out using a 638 nm laser and the emission was collected in the range of 642-745 nm. Data was processed using IDEAS v6.3.

### In Vivo Experiments

Animal experiments were approved by the Institutional Animal Care and Use Committee (IACUC), National University of Singapore (R20-1178) and carried out in line with procedures in the Guide for the Care and Use of Laboratory Animals (National Institutes of Health). C57BL6 mice (female, 18-20 g) were anaesthetized by ketamine and the hair at the back were shaved and removed. A 6 mm-diameter excisional wound was created on the back using a biopsy punch. Log phase MRSA (in 5 μl PBS) were inoculated onto the wound. A 3M tegaderm were used to cover the wound site from contamination. 2 hr post infection, DM6P in saline solution (500 μg/ml, 0.25 mg/kg) or vehicle ctrl (saline) solution were added to the wound site and left dry for 10 minutes. A new tegaderm were applied to the wound site. 24 hr post infection, all the mice were sacrificed, and the wound tissue were harvested into 1 ml PBS. The samples were homogenized, 10-fold serially diluted, and plated onto TSA plates. CFU were numerated after 16 hr incubation at 37° C. Significant levels were evaluated by a one-way ANOVA followed by a multiple comparison analysis of variance by a one-way Tukey test (Graphpad PRISM).

For histological analysis, a second group of mice were treated in a similar manner and monitored for 14 days post-treatment. At the end-point, mice were sacrificed and the individual organs and blood samples were collected. Tissues were fixed in 10% neutral-buffered formalin (NBF) for 48 hours and subjected to H&E staining and examination. Clinical blood biomarkers were analysed with a Pointcare® cM4 Blood Chemistry Analyzer (Tianjin MNCHIP Technologies Co., Ltd) according to the manufacturer's protocol.

### Animal Studies

For testing against Staphylococcus pseudintermedius, C57BL/6[SPF] mice (female, 18-20 g) were first acclimated, weighed and grouped based on body weight into 3 groups. Mice were anaesthetized and the hair at the back will be shaved and removed. A 6 mm-diameter excisional wound was created on the back of each mouse, and log-phase Staphylococcus pseudintermedius (Sp strain) (in 5 μL PBS) will be inoculated onto the wound. A 3M tegaderm will be used to cover the wound site from contamination. 2 h post infection, the groups were tested with saline, DM6P (0.1 mg/kg) and DM6P (0.25 mg/kg) respectively, by adding directly to wound site. At 12 h and 24 h post infection, sampling and colony enumeration were conducted. At 24 h post infection, all mice were sacrificed and the wound tissue harvested into 1 mL PBS.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A compound of Formula (I) or a pharmaceutically acceptable salt, solvate or isomer thereof: 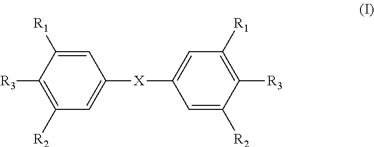
wherein
each R₁, R₂ and R₃ are independently selected from H, optionally substituted alkyl, optionally substituted alkoxy;
wherein at least one of R₁, R₂ and R₃ on each phenylene ring is 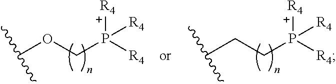
wherein each R₄ is independently selected from optionally substituted aryl, optionally substituted heteroaryl, optionally substituted heterocyclyl, optionally substituted cycloalkyl, and optionally substituted cycloalkenyl;
n is an integer selected from 2 to 10; and
X is a linker configured to maintain the π-π conjugation between the two phenylene rings.

2. The compound according to claim 1, wherein X is selected from 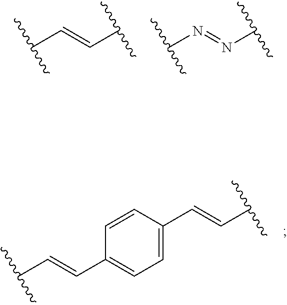
wherein [symbol] represents a bond to either phenylene ring.

3. The compound according to claim 1, wherein the compound is a compound of Formula (IIa) or a pharmaceutically acceptable salt, solvate or isomer thereof: 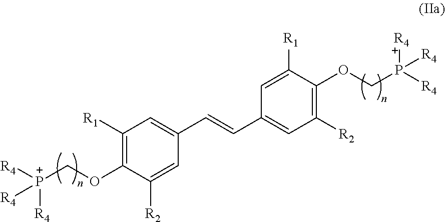
wherein
each R₁ is independently selected from H, optionally substituted alkyl, and optionally substituted alkoxy;
each R₂ is independently selected from H, optionally substituted alkyl, and optionally substituted alkoxy;
each R₃ is independently selected from optionally substituted aryl, optionally substituted heteroaryl, optionally substituted heterocyclyl, optionally substituted cycloalkyl, and optionally substituted cycloalkenyl; and
n is an integer selected from 4 to 10.

4. The compound according to claim 1, wherein R₁ is independently optionally substituted methoxy and R₂ is H.

5. The compound according to claim 1, wherein at least one R₄ is optionally substituted aryl.

6. The compound according to claim 1, wherein the compound is characterised by a trans or E configuration.

7. The compound according to claim 1, wherein the compound is selected from:

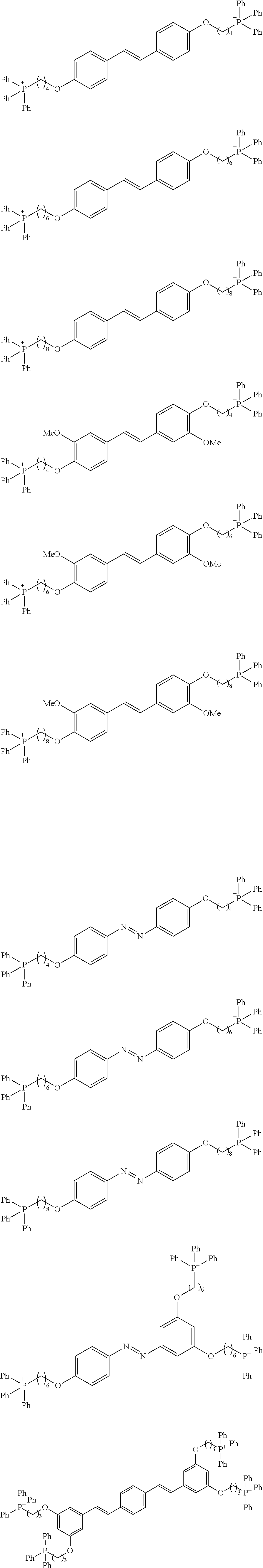

8. The compound according to claim 1, wherein the compound is characterised by at least one of the following:
a) a solubility in an aqueous medium of about 2 μg mL⁻¹ to about 200 μg mL⁻¹, or preferably about 4 μg mL⁻¹ to about 138 μg mL⁻¹;
b) a minimum inhibitory concentration (MIC) against microbe of about 0.5 μg mL⁻¹ to about 64 μg mL⁻¹;
c) a minimum inhibitory concentration (MIC) against Gram-negative bacteria of about 0.5 μg mL⁻¹ to about 64 μg mL⁻¹;
d) a minimum inhibitory concentration (MIC) against Gram-positive bacteria of about 0.5 μg mL⁻¹ to about 16 μg mL⁻¹;
e) a IC₅₀ against mammalian cells of about 5 μg mL⁻¹ to about 256 μg mL⁻¹;
f) a selectivity index (IC₅₀/MIC) of about 2 to about 100; and
g) a minimum bactericidal concentration (MBC) of about 0.5 μg mL⁻¹ to 64 μg mL⁻¹;
wherein the MIC is not affected by a presence of protein and/or salt in the aqueous medium.

9-15. (canceled)

16. The compound according to claim 1, wherein a microbe in contact with the compound does not develop a resistance.

17. The compound according to claim 1, wherein a bacterial membrane in a bacterial cell in contact with the compound is depolarized.

18. A pharmaceutical composition, comprising a compound according to claim 1 or a pharmaceutically acceptable salt, solvate or isomer thereof, and optionally in combination with an excipient.

19. A composition, comprising a compound according to claim 1 or a salt, solvate or isomer thereof, and optionally in combination with an excipient.

20. A method of treating a bacterial infection or disease, comprising administrating to a subject in need thereof a therapeutical effective amount of the compound of according to claim 1 or a pharmaceutically acceptable salt, solvate or isomer thereof.

21-22. (canceled)

23. The method according to claim 20, wherein the compound or a pharmaceutically acceptable salt, solvate or isomer thereof is provided to the subject in need thereof at about 0.05 mg/kg to about 10 mg/kg.

24. The method according to claim 20, wherein the bacterial in the bacterial infection or disease is an antibiotic resistant bacterial.

25. The method according to claim 20, wherein the bacterial in the bacterial infection or disease is a Gram-negative bacterial or Gram-positive bacterial.

26. The method according to claim 20, wherein the bacteria is selected from E. coli, P. aeruginosa, K. pneumonia, A. baumanii, S. aureus, Methicillin-resistant S. aureus, E. faecalis, E. facium, and non-tuberculous mycobacteria.

27. The method according to claim 20, wherein the bacterial infection or disease is a bacteria skin infection or food-borne infection.

28. A method of disinfecting a surface, comprising contacting the compound according to claim 1 with the surface.

29. The method according to claim 28, wherein the surface is a non-biological surface.
